(19) United States
(12) Patent Application Publication
(10) Pub. No.: US 2025/0163212 A1
(43) Pub. Date: May 22, 2025

(54) METHOD OF MAKING SULFONATED POLYPHENYLENES

(71) Applicant: IONOMR INNOVATIONS INC., Vancouver (CA)

(72) Inventors: Simon Cassegrain, Vancouver (CA); Thomas Skalski, Delta (CA)

(73) Assignee: IONOMR INNOVATIONS INC., Vancouver (CA)

(21) Appl. No.: 18/948,244

(22) Filed: Nov. 14, 2024

Related U.S. Application Data
(60) Provisional application No. 63/600,380, filed on Nov. 17, 2023.

(51) Int. Cl. C08G 61/10

(52) U.S. Cl. CPC C08G 61/10; C08G 2261/12; C08G 2261/1452; C08G 2261/64; C08G 2340/00

(57) ABSTRACT

Described herein is a method for making sulfonated polyphenylene polymers and the uses thereof. Such sulfonated polyphenylene polymers, and membranes prepared therefrom, have applications in fuel cells, water electrolyzers, water purification, battery products, and other electrochemical devices.

### CROSS-REFERENCE TO RELATED APPLICATION

This application claims the benefit of U.S. Application No. 63/600,380 filed on Nov. 17, 2023, the disclosure of which is hereby incorporated by reference in its entirety.

### FIELD OF THE INVENTION

The present invention relates to an improved solution polymerization process for production of sulfonated polyphenylene polymer. The improved process results in the following advantages: reduced reaction time, reduced temperature, reduced power consumption, and control over polymer molecular weight.

### BACKGROUND

Polymer electrolyte membranes (PEMs) show great potential as components of fuel cells and solar cells, as well as for electrolysis, dialysis, and water splitting devices.

The standard material used for most PEMs is Nafion®, a commercially-available poly(tetrafluoroethylene) with pendant perfluorosulfonic acids, and which possesses low water uptake and high proton conductivity. However, Nafion® suffers from limited operation temperature (0-80° C.), high cost, and high fuel cross-over. Furthermore, the use and disposal of fluorinated products such as Nafion® causes environmental toxicity. Consequently, hydrocarbon-based polymer electrolytes, due to their synthetic versatility, high chemical stability, relatively low cost, and decreased environmental toxicity are emerging as an important class of alternative materials for PEMs in electrochemical applications.

Polyphenylene (PP) is a class of hydrocarbon polymer consisting primarily of phenylene units, as represented by poly(para-phenylene).

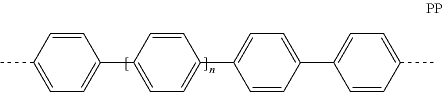

Poly(para-phenylene) can be substituted with bulky alkyl chains and/or additional aryl groups.

Initially, the Lewis acid-mediated oxidative aryl-aryl coupling of benzenes was investigated where linear oligo(para-phenylene)s and phenylated polyphenylenes (PPP) were formed. However, such polyphenylenes exhibited structural defects, limited solubility, and a low degree of polymerization (DP).

Since this initial work, other routes have been developed for the synthesis of various PPs via, for example, metal-catalyzed aryl-aryl couplings and cyclotrimerization of alkynes, thermal ring opening of biphenylenes, and Diels-Alder (D-A) reactions.

An A₂B₂-type D-A polymerization using cyclopentadienone (Cp) units as diene for synthesizing phenylated PPs was developed. The synthesis was accomplished by repetitive D-A reaction of bis-Cps as an A₂ monomer and bisacetylene as a B₂ monomer in toluene at 300° C. in a sealed tube. However, the polymer backbones of such polymers consisted of random mixtures of para- and meta-phenylenes, and isomerization was possible upon each cycloaddition step due to the asymmetrical diene structure of the bis-Cps.

Subsequently, a series of hydrocarbon-based PP polyelectrolytes were synthesized and investigated. These polyelectrolytes were achieved by sulfonation or bromination/amination of phenylated PPs functionalized after initial D-A polymerization.

The ion exchange capacity (IEC) of such polyelectrolytes varied between 0.98 and 2.2 mequiv/g, corresponding to 0.8-2.1 sulfonic acid groups per repeating unit. These materials were soluble in polar aprotic solvents such as N,N′-dimethylacetamide (DMAc) and N-methyl-2-pyrrolidone (NMP), while remaining insoluble in nonpolar organic solvents and water.

However, a major drawback of post-polymerization sulfonated PPs is the irregular sulfonation which results. For example, the extent of sulfonation can vary based on the reaction conditions; the degree of sulfonation varies as between monomers; and sulfonation can occur at different positions within a given monomer thus rendering variation between monomers in the sulfonate position. Consequently, this irregularity negatively impacts polymer characteristics and macroscopic properties. In addition, such polymers cannot be synthesized reproducibly.

To increase the molecular precision and reproducibility of sulfonated PP polymers, research has turned to generating sulfonated monomeric units prior to polymerization. Such polymers were prepared by heating trialkyl ammonium sulfonate salts of 4,4′-(1,4-phenylene)-bis-(2,3,5-triphenylcyclopenta-2,4-dien-1-one) with various bis-alkynes in nitrobenzene at 215° C. for 48 hours. The obtained polymers were converted to sulfonic acid form in multiple steps post-polymerization.

Although the pre-sulfonation of D-A monomer allows for precise placement of exact numbers of sulfonic acid groups within each monomer and the polymer, and reproducibly produces polymer products, the monomer solubility requirements have necessitated use of the undesirable and toxic solvent nitrobenzene. An additional drawback of a method utilizing nitrobenzene is precipitation of the polymer product during polymerization. Insolubility of the sulfonated D-A polymers in nitrobenzene presents a major synthetic problem as it limits the polymer molecular weight that can be obtained before the growing polymer chains precipitate out of solution during synthesis, thus precluding synthesis of corresponding higher molecular weight polymers.

Further, isolation of final target sulfonated polymers from such methods is inefficient, cumbersome, time-consuming, and costly.

Therefore, a need exists for a method for preparing and easily recovering controlled, reproducible, small to large molecular weight range, sulfonic acid-containing polyphenylene polymers, which utilize a non-toxic polymerization solvent or mixture of solvents.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect of the disclosure, provided herein is a method of making a sulfonated polyphenylene polymer, comprising:
polymerizing a sulfonated bis-cyclopentadienone of Formula (I) with a diethynyl arene of Formula (II) in one or more solvents, to form a sulfonated polyphenylene polymer having a repeat unit (x) of Formula (III),
wherein Formula (I) has the structure:

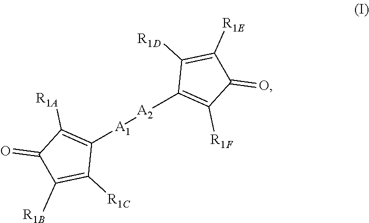

wherein Formula (II) has the structure:

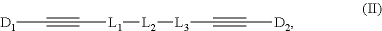

and
wherein:
R_{1A}, R_{1B}, R_{1C}, R_{1D}, R_{1E}, and R_{1F} are independently aryl or heteroaryl, each unsubstituted or substituted with 1, 2, 3, 4, or 5 substituents independently selected from C₁₋₆ alkyl, halo, SO₃⁻X⁺, PO₃²⁻2X⁺, and COO⁻X⁺, and provided that at least two of R_{1A}, R_{1B}, R_{1C}, R_{1D}, R_{1E}, and R_{1F} are independently aryl or heteroaryl substituted with 1, 2, 3, 4, or 5 substituents independently selected from SO₃⁻X⁺, PO₃²⁻2X⁺, and COO⁻X⁺;
A₁ is arylene, heteroarylene, aralkylene, or heteroaralkylene, wherein said arylene, heteroarylene, aralkylene, and heteroaralkylene are unsubstituted or substituted with 1, 2, 3, or 4 substituents independently selected from halo, nitro, cyano, aryl, and heteroaryl;
A₂ is absent, arylene, or heteroarylene, wherein said arylene and heteroarylene are unsubstituted or substituted with 1, 2, 3, or 4 substituents independently selected from halo, nitro, cyano, aryl, and heteroaryl;
L₁ is an unsubstituted or substituted linking heteroatom, arylene, heteroarylene, aralkylene, or heteroaralkylene, wherein the arylene, heteroarylene, aralkylene, and heteroaralkylene are unsubstituted or substituted with 1, 2, 3, or 4 substituents independently selected from C₁₋₆ alkyl, halo, nitro, cyano, aryl, and heteroaryl;
L₂ and L₃ are each independently absent, arylene, or heteroarylene, wherein said arylene and heteroarylene are unsubstituted or substituted with 1, 2, 3, or 4 substituents independently selected from C₁₋₆ alkyl, halo, nitro, cyano, aryl, and heteroaryl;
D₁ and D₂ are each independently H, R_{1G}, or R_{1H};
R_{1G} and R_{1H} are each independently H, aryl, or heteroaryl, wherein the aryl and heteroaryl are unsubstituted or substituted with 1, 2, 3, 4, or 5 substituents independently selected from C₁₋₆ alkyl, halo, nitro, cyano, SO₃⁻X⁺, PO₃²⁻2X⁺, and COO⁻X⁺; and
X⁺ is H⁺ or a cation, and
wherein the one or more solvent is not nitrobenzene.

In another aspect of the disclosure, provided herein is a method of forming a sulfonated polyphenylene polymer, sulfonated polyphenylene copolymer, branched sulfonated polyphenylene polymer, branched sulfonated polyphenylene copolymer, hyperbranched sulfonated polyphenylene polymer, or hyperbranched sulfonated polyphenylene copolymer, for use in an ionomeric membrane.

In a further aspect of the disclosure, provided herein is an electrochemical device comprising the sulfonated polyphenylene polymer, sulfonated polyphenylene copolymer, branched sulfonated polyphenylene polymer, branched sulfonated polyphenylene copolymer, hypethranched sulfonated polyphenylene polymer, or hyperbranched sulfonated polyphenylene copolymer as disclosed herein, or the ionomeric membrane disclosed herein, wherein the electrochemical device is a fuel cell, an electrolyzer, a redox flow battery, or another electrochemical device.

### DETAILED DESCRIPTION

The object of the present invention is to provide a method for making sulfonated polyphenylene polymers for use in, but not restricted to, electrochemical devices such as fuel cells, electrolyzers, and redox flow batteries.

### Definitions

The terminology used in the description of the disclosure herein is for the purpose of describing particular embodiments and is not intended to be limiting for the disclosed technology.

The term “substituted” means that an atom or group of atoms formally replaces hydrogen as a “substituent” attached to another group. The term “substituted,” unless otherwise indicated, refers to any level of substitution, e.g., mono-, di-, tri-, tetra-, penta-, or higher substitution, where such substitution is permitted (e.g., results in a stable compound). The substituents are independently selected, and substitution may be at any chemically accessible position. It is to be understood that substitution at a given atom is limited by valency.

When a group is unsubstituted, it can be referred to as the group name, for example alkyl or aryl.

Substituents of polymers of the disclosure are disclosed herein in groups or in ranges. It is specifically intended that the disclosure include each and every individual subcombination of the members of such groups and ranges. For example, the term “C₁₋₆ alkyl” is specifically intended to individually disclose (without limitation) methyl, ethyl, C₃ alkyl, C₄ alkyl, C₅ alkyl, and C₆ alkyl, and to include linear or branched geometric isomers when such geometric isomers are possible. For example, C₄ alkyl can be n-butyl, sec-butyl, isobutyl, or tert-butyl.

It is further appreciated that certain features of the disclosure, which are, for clarity, described in the context of separate embodiments, can also be provided in combination in a single embodiment. Conversely, various features of the disclosure which are, for brevity, described in the context of a single embodiment, can also be provided separately or in any suitable subcombination.

As used herein, the term “alkyl” refers to straight, branched, or cyclic hydrocarbon groups. In some embodiments, alkyl has 1 to 6 carbon atoms, 1 to 5 carbon atoms, 1 to 4 carbon atoms, 1 to 3 carbon atoms, 1 or 2 carbon atoms, or 1 carbon atom. Representative alkyl groups include methyl, ethyl, propyl (e.g., n-propyl, isopropyl, cyclopropyl), butyl (e.g., n-butyl, sec-butyl, isobutyl, tert-butyl, cyclobutyl), pentyl (e.g., n-pentyl, tert-pentyl, neopentyl, isopentyl, pentan-2-yl, pentan-3-yl, cyclopentyl), and hexyl (e.g., n-hexyl, geometric isomers, cyclohexyl) groups.

As used herein, the term “alkylene” refers to a linking alkyl group.

As used herein, the term “aryl” refers to an aromatic hydrocarbon group having 6 to 14 carbon atoms. Representative aryl groups include phenyl groups and naphthyl groups. In some embodiments, the term “aryl” includes monocyclic or polycyclic (e.g., having 2 or 3 fused rings) aromatic hydrocarbons such as, for example, phenyl, naphthyl, anthracenyl, phenanthrenyl, indanyl, and indenyl.

As used herein, the term “arylene” refers to a linking aryl group. For example, the term “phenylene” refers to a linking phenyl group.

As used herein, the term “aralkyl” refers to an alkyl group as defined herein, with an aryl group as defined herein, substituted for one of the alkyl hydrogen atoms. A representative aralkyl group is a benzyl group.

As used herein, the term “aralkylene” refers to a linking aralkyl group.

As used herein, the term “heteroaryl” refers to a 5- to 10-membered aromatic monocyclic or bicyclic ring containing 1-4 heteroatoms selected from 0, S. and N. Representative 5- or 6-membered aromatic monocyclic ring groups include pyridine, pyrimidine, pyridazine, furan, thiophene, thiazole, oxazole, and isooxazole. Representative 9- or 10-membered aromatic bicyclic ring groups include benzofuran, benzothiophene, indole, pyranopyrrole, benzopyran, quinoline, benzocyclohexyl, and naphthyridine.

As used herein, the term “heteroarylene” refers to a linking heteroaryl group.

As used herein, the term “heteroaralkyl” refers to an alkyl group as defined herein with a heteroaryl group as defined herein substituted for one of the alkyl hydrogen atoms. For example, a representative heteroaralkyl group is an alkylpyridyl group.

As used herein, the term “heteroaralkylene” refers to a linking heteroaralkyl group.

As used herein, the term “halogen” or “halo” refers to fluoro, chloro, bromo, and iodo groups. “Halogen” or “halo” can refer to the entire set of fluoro, chloro, bromo, and iodo groups, or to a subset of halogen atoms, e.g. fluoro, chloro, and bromo; chloro, bromo, and iodo; and any other combination or subcombination of halogen atoms.

As used herein, the term “heteroatomic” or “heteroatomic groups” refers to one or more heteroatoms, wherein the one or more heteroatoms is selected from N, O, and S.

As used herein, the term “copolymer” refers to a polymer that is the result of polymerization of two or more different monomeric units. The number and the nature of each monomeric unit can be separately controlled in a copolymer. The copolymer comprises at least one monomeric unit which is ionomeric or a sulfonated polyphenylene polymer, and at least one monomeric unit which is not ionomeric, or is uncharged. The ionomeric monomers in the copolymer can be the same or can be different. The uncharged monomers in the copolymer can be the same or can be different.

As used herein, the term “repeat unit” or “repeating unit” corresponds to the smallest monomeric unit, the repetition of which constitutes a macromolecule, or a polymer chain. The monomeric unit is a repeat unit within the polymer chain. As used herein, monomeric unit and repeat unit are used interchangeably. The monomeric unit of a polymer chain refers to a group of atoms in the monomer which comprise the backbone, together with its pendant atoms or groups of atoms. The monomeric units in a polymer chain may be the same, or may be different. For example, any monomeric unit can comprise one, two, three, or four sulfonate groups, or any monomeric unit can lack any sulfonate groups. The monomeric unit can also refer to an end group on the polymer chain. For example, the monomeric unit of polyethylene glycol can be —CH₂CH₂O— corresponding to a repeating unit, or —CH₂CH₂OH corresponding to an end group. As used herein, the term “end group” refers to a repeating unit, or monomeric unit, with only one attachment to the polymer chain, located at an end of the polymer chain.

The repeat units can be disposed in a purely random, an alternating random, a regular alternating, a statistical, a regular block, or a random block configuration unless expressly stated to be otherwise. The repeat units can be connected end on end to form a polymer which is linear in its primary structure, or the repeat units can be connected in a polymer which is branched.

As used herein, the term “random copolymer” is a copolymer having an irregular mixture of two or more monomeric units. The distribution of the monomeric units throughout the polymer can be a statistical distribution, or approach a statistical distribution, of the repeat units. In some embodiments, the distribution of one or more of the monomeric units is favored. A purely random configuration can, for example, be: x x y z x y y z y z z z . . . or y z x y z y z x x . . . . An alternating random configuration can be: x y x z y x y z y x z . . . , and a regular alternating configuration can be: x y z x y z x y z . . . .

As used herein, the term “statistical copolymer” is a copolymer having a composition of monomeric units as determined by the mole percent of monomeric units used to generate the polymer. For example, in a statistical copolymer comprising 90% ionomeric monomer and 10% uncharged monomer, the resulting polymer is expected to consist of about 90% ionomeric monomer units and about 10% uncharged monomer units. A statistical polymer comprises an average composition ratio of x and y monomer units.

A regular block configuration (i.e., a block copolymer) has the following example configuration when comprising 3 different monomeric units (x, y, and z) for the block: . . . x x x y y y z z z x x x . . . , while a random block configuration has the following general example configuration of, for example: . . . x x x z z z x x x y y y y z z z x x x z z z z . . . , or for example, . . . x-x-x-y-y-y-y-x-x-x-y-y-y-x-x-x-x-y-y-y . . . . A block copolymer comprises blocks of 3 or more of the same monomeric unit.

As used herein, the term “cationic” refers to a moiety that is positively charged, or ionizable to a positively charged moiety under chemical or acidic conditions relative to the pKa of an atom. Examples of cationic moieties include, for example, ammonium, iminium, imidazolium, oxazolium, thiazolium groups, etc.

A weight percent (wt %) of a component is based on the weight relative to another component of the composition or solution in which the component is included. Unless specified otherwise, weight percent is intended to constitute the weight of a composition in its dry form.

As used herein, the term “linear” refers to a polymer with a backbone which extends unilaterally, or comprises backbone atoms, functional groups, moieties, and/or repeat units which are bound together end on end without branching. A linear polymer may not be in a straight line per se, but may be bent due to the bonding configuration (e.g. ortho- or meta-substitution of a phenyl ring) of the backbone atoms, functional groups, moieties, and/or repeat units, or due to rotation about a bond (e.g. C—C bond) which causes the linear chain to bend or fold. A linear polymer includes a polymer comprising of monomeric units which have substituents or pendent groups which may extend away from the polymer backbone.

As used herein, the term “branched” refers to a polymer that includes side chains or “branches” growing out from a main polymeric segment (e.g., a polymer backbone). The branching is composed of the same repeating units as the main segment. A branched ionomeric polymer comprises branching monomers at a relatively low abundance in the polymer. Branched ionomeric polymers can include a mixture of linear and branched segments. Branched ionomeric polymers can be branched sulfonated polyphenylene polymers, or can be branched sulfonated polyphenylene copolymers.

As used herein, the term “hyperbranched” refers to a polymer that includes a three-dimensional polymeric structure that differs from regular dendrimer structures, and which can include a mixture of linear and branched segments. Hyperbranched ionomeric polymers comprise a relatively high abundance of branching comonomers in the ionomeric polymer than exists in branched ionomeric polymers. Hyperbranched ionomeric polymers can be hyperbranched sulfonated polyphenylene polymers, or can be hyperbranched sulfonated polyphenylene copolymers. For example, a polymer composition resulting from the method comprising a branching compound of Formula (VIII) between about 20 mol % and about 40 mol %, between about 20 mol % and about 30 mol %, between about 20 mol % and about 25 mol %, between about 18 mol % and about 22 mol %, or about 20 mol % can result in a hyperbranched ionomeric polymer or a hyperbranched ionomeric copolymer. Hyperbranched ionomeric polymers or copolymers typically comprise few or no linear segments.

As used herein, “molecular weight,” or “MW,” refers to number-average molecular weight which can be measured by ¹H NMR spectroscopy, gel permeation chromatography (GPC), viscosity, falling ball viscosity, or other analytical methods. Differences in molecular weights of a polymer synthesized by the same method may be estimated by comparing viscosity of polymer solutions.

As used in the description of the invention and the appended claims, the singular forms “a”, “an” and “the” are intended to include the plural forms as well, unless the context clearly indicates otherwise.

As used herein, the term “about” can be understood to include values within 10% of the stated value. For example, a temperature of “about 100° C.” means the temperature is 100±10° C. Otherwise stated, the temperature is 90° C.-110° C.

It is further intended that the compounds of the disclosure are stable. As used herein, “stable” refers to a compound that is sufficiently robust to survive isolation to a useful degree of purity from a reaction mixture. “Stable” also refers to a polymer that can withstand heating as a polymer film and at 100-120° C. for at least 24 hours without appreciable chemical degradation. The “stability” of the polymer can be verified by analyzing its ¹H NMR spectrum after heating at these conditions and comparing it to that of the pristine polymer.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the present application and relevant art, and should not be interpreted in an idealized or overly formal sense unless expressly so defined herein.

### Method of Making a Sulfonated Polyphenylene Polymer

In one aspect, the present disclosure provides a method of making a sulfonated polyphenylene polymer, comprising:
polymerizing a sulfonated bis-cyclopentadienone of Formula (I) with a diethynyl arene of Formula (II) in one or more solvents.

In some embodiments, Formula (I) has the structure:

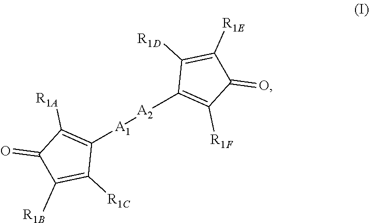

wherein:
R_{1A}, R_{1B}, R_{1C}, R_{1D}, R_{1E}, and R_{1F} are independently aryl or heteroaryl, each unsubstituted or substituted with 1, 2, 3, 4, or 5 substituents independently selected from C₁ alkyl, halo, SO₃⁻X⁺, PO₃²⁻2X⁺, and COO⁻X⁺, and provided that at least two of R_{1A}, R_{1B}, R_{1C}, R_{1D}, R_{1E}, and R_{1F} are independently aryl or heteroaryl substituted with 1, 2, 3, 4, or 5 substituents independently selected from SO₃⁻X⁺, PO₃²⁻2X⁺, and COO⁻X⁺;
A₁ is arylene, heteroarylene, aralkylene, or heteroaralkylene, wherein said arylene, heteroarylene, aralkylene, and heteroaralkylene are unsubstituted or substituted with 1, 2, 3, or 4 substituents independently selected from halo, nitro, cyano, aryl, and heteroaryl;
A₂ is absent, arylene, or heteroarylene, wherein said arylene and heteroarylene are unsubstituted or substituted with 1, 2, 3, or 4 substituents independently selected from halo, nitro, cyano, aryl, and heteroaryl; and
X⁺ is H⁺ or a cation.

In some embodiments, Formula (II) has the structure:

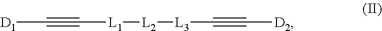

wherein:
L₁ is an unsubstituted or substituted linking heteroatom, arylene, heteroarylene, aralkylene, or heteroaralkylene, wherein the arylene, heteroarylene, aralkylene, and heteroaralkylene are unsubstituted or substituted with 1, 2, 3, or 4 substituents independently selected from C₁₋₆ alkyl, halo, nitro, cyano, aryl, and heteroaryl;
L₂ and L₃ are each independently absent, arylene, or heteroarylene, wherein said arylene and heteroarylene are unsubstituted or substituted with 1, 2, 3, or 4 substituents independently selected from C₁₋₆ alkyl, halo, nitro, cyano, aryl, and heteroaryl;
D₁ and D₂ are each independently H, R_{1G}, or R_{1H};
R_{1G} and R_{1H} are each independently H, aryl, or heteroaryl, wherein the aryl and heteroaryl are unsubstituted or substituted with 1, 2, 3, 4, or 5 substituents independently selected from C₁₋₆ alkyl, halo, nitro, cyano, SO₃⁻X⁺, PO₃²⁻2X⁺, and COO⁻X⁺; and
X⁺ is H⁺ or a cation.

In some embodiments, the polymerizing a sulfonated bis-cyclopentadienone of Formula (I) with a diethynyl arene of Formula (II) in one or more solvents forms a sulfonated polyphenylene polymer having a repeat unit (x) of Formula (III). In some embodiments, the sulfonated polyphenylene polymer has a repeat unit (x) of Formula (III), and Formula (III) has the structure:

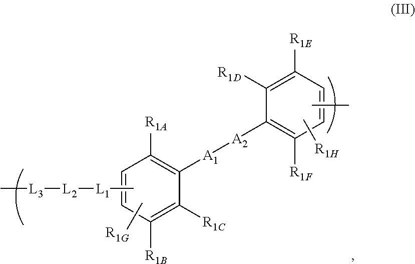

wherein:
R_{1A}, R_{1B}, R_{1C}, R_{1D}, R_{1E}, and R_{1F} are independently aryl or heteroaryl, each unsubstituted or substituted with 1, 2, 3, 4, or 5 substituents independently selected from C₁₋₆ alkyl, halo, nitro, cyano, SO₃⁻X⁺, PO₃²⁻2X⁺, and COO⁻X⁺, and provided that at least two of R_{1A}, R_{1B}, R_{1C}, R_{1D}, R_{1E}, and R_{1F} are independently aryl or heteroaryl substituted with 1, 2, 3, 4, or 5 substituents independently selected from SO₃⁻X⁺, PO₃²⁻2X⁺, and COO⁻X⁺;
R_{1G} and R_{1H} are each independently H, aryl, or heteroaryl, wherein said aryl and heteroaryl are unsubstituted or substituted with 1, 2, 3, 4, or 5 substituents independently selected from C₁₋₆ alkyl, halo, nitro, cyano, SO₃⁻X⁺, PO₃²⁻2X⁺, and COO⁻X⁺;
A₁ is arylene, heteroarylene, aralkylene, or heteroaralkylene, wherein said arylene, heteroarylene, aralkylene, and heteroaralkylene are unsubstituted or substituted with 1, 2, 3, or 4 substituents independently selected from halo, nitro, cyano, aryl, and heteroaryl;
A₂ is absent, arylene, or heteroarylene, wherein said arylene and heteroarylene are unsubstituted or substituted with 1, 2, 3, or 4 substituents independently selected from halo, nitro, cyano, aryl, and heteroaryl;
L₁ is an unsubstituted or substituted linking heteroatom, arylene, heteroarylene, aralkylene, or heteroaralkylene, wherein said arylene, heteroarylene, aralkylene, and heteroaralkylene are unsubstituted or substituted with 1, 2, 3, or 4 substituents independently selected from C₁ alkyl, halo, nitro, cyano, aryl, and heteroaryl;
L₂ and L₃ are each independently absent, arylene, or heteroarylene, wherein said arylene and heteroarylene are unsubstituted or substituted with 1, 2, 3, or 4 substituents independently selected from C₁₋₆ alkyl, halo, nitro, cyano, aryl, and heteroaryl; and
X⁺ is H⁺ or a cation.

In some embodiments, the method further comprises polymerizing with a bis-cyclopentadienone of Formula (IV) to form a sulfonated polyphenylene copolymer.

In some embodiments, Formula (IV) has the structure:

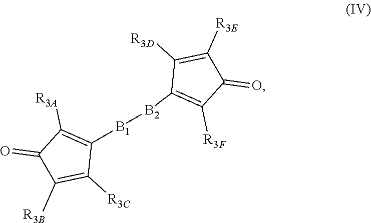

R_{3A}, R_{3B}, R_{3C}, R_{3D}, R_{3E}, and R_{3F} are independently aryl or heteroaryl, each unsubstituted or substituted with 1, 2, 3, 4, or 5 substituents independently selected from C₁₋₆ alkyl, halo, nitro, and cyano;
B₁ is arylene, heteroarylene, aralkylene, or heteroaralkylene, wherein said arylene, heteroarylene, aralkylene, and heteroaralkylene are unsubstituted or substituted with 1, 2, 3, or 4 substituents independently selected from halo, nitro, cyano, aryl, and heteroaryl; and
B₂ is absent, arylene, or heteroarylene, wherein said arylene and heteroarylene are unsubstituted or substituted with 1, 2, 3, or 4 substituents independently selected from halo, nitro, cyano, aryl, and heteroaryl.

In some embodiments, the sulfonated polyphenylene copolymer comprises a hydrophobic polyphenylene repeat unit (y) of Formula (V).

In some embodiments, Formula (V) has the structure:

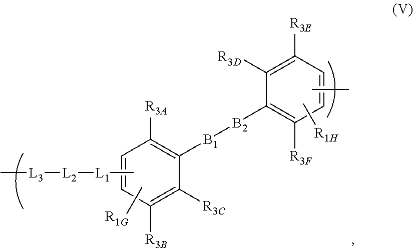

wherein:
R_{3A}, R_{3B}, R_{3C}, R_{3D}, R_{3E}, and R_{3F} are independently aryl or heteroaryl, each unsubstituted or substituted with 1, 2, 3, 4, or 5 substituents independently selected from C₁₋₆ alkyl, halo, nitro, and cyano;
R_{1G} and R_{1H} are independently H, aryl, or heteroaryl, wherein said aryl and heteroaryl are unsubstituted or substituted with 1, 2, 3, 4, or 5 substituents independently selected from C₁₋₆ alkyl, halo, nitro, and cyano;
B₁ is independently arylene, heteroarylene, aralkylene, or heteroaralkylene, wherein said arylene, heteroarylene, aralkylene, and heteroaralkylene are unsubstituted or substituted with 1, 2, 3, or 4 substituents independently selected from halo, nitro, cyano, aryl, and heteroaryl;
B₂ is independently absent, arylene, or heteroarylene, wherein said arylene and heteroarylene are unsubstituted or substituted with 1, 2, 3, or 4 substituents independently selected from halo, nitro, cyano, aryl, and heteroaryl;
L₁ is independently an unsubstituted or substituted linking heteroatom, arylene, heteroarylene, aralkylene, or heteroaralkylene, wherein said arylene, heteroarylene, aralkylene, and heteroaralkylene are each unsubstituted or substituted with 1, 2, 3, or 4 substituents independently selected from C₁₋₆ alkyl, halo, nitro, cyano, aryl, and heteroaryl; and
L₂ and L₃ are independently absent, arylene, or heteroarylene, wherein said arylene and heteroarylene are unsubstituted or substituted with 1, 2, 3, or 4 substituents independently selected from C₁₋₆ alkyl, halo, nitro, cyano, aryl, and heteroaryl.

In some embodiments, the sulfonated polyphenylene copolymer has a structure of Formula (VI):

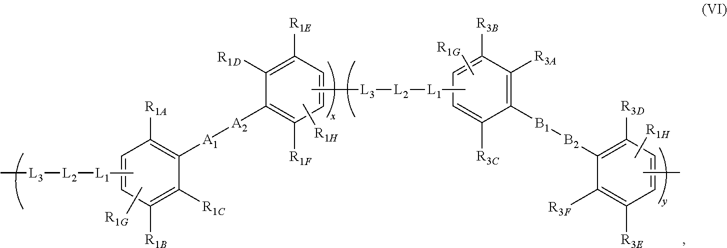

wherein:
R_{1A}, R_{1B}, R_{1C}, R_{1D}, R_{1E}, and R_{1F} are independently aryl or heteroaryl, each unsubstituted or substituted with 1, 2, 3, 4, or 5 substituents independently selected from C₁₋₆ alkyl, halo, nitro, cyano, SO₃⁻X⁺, PO₃²⁻2X⁺, and COO⁻X⁺;
R_{3A}, R_{3B}, R_{3C}, R_{3D}, R_{3E}, and R_{3F} are independently aryl or heteroaryl, each unsubstituted or substituted with 1, 2, 3, 4, or 5 substituents independently selected from C₁₋₆ alkyl, halo, nitro, and cyano;
R_{1G} and R_{1H} are each independently H, aryl, or heteroaryl, wherein said aryl and heteroaryl are unsubstituted or substituted with 1, 2, 3, 4, or 5 substituents independently selected from C₁₋₆ alkyl, halo, nitro, cyano, SO₃⁻X⁺, PO₃²⁻2X⁺, and COO⁻X⁺;
A₁ and B₁ are each independently arylene, heteroarylene, aralkylene, or heteroaralkylene, wherein said arylene, heteroarylene, aralkylene, and heteroaralkylene are unsubstituted or substituted with 1, 2, 3, or 4 substituents independently selected from C₁ 6 alkyl, halo, nitro, cyano, aryl, and heteroaryl;
A₂ and B₂ are each independently absent, arylene, or heteroarylene, wherein said arylene and heteroarylene are unsubstituted or substituted with 1, 2, 3, or 4 substituents independently selected from C₁₋₆ alkyl, halo, nitro, cyano, aryl, and heteroaryl;
L₁ are each independently an unsubstituted or substituted linking heteroatom, arylene, heteroarylene, aralkylene, or heteroaralkylene, wherein said arylene, heteroarylene, aralkylene, and heteroaralkylene are unsubstituted or substituted with 1, 2, 3, or 4 substituents independently selected from C₁₋₆ alkyl, halo, nitro, cyano, aryl, and heteroaryl;
L₂ and L₃ are each independently absent, arylene, or heteroarylene, wherein said arylene and heteroarylene are unsubstituted or substituted with 1, 2, 3, or 4 substituents independently selected from C₁₋₆ alkyl, halo, nitro, cyano, aryl, and heteroaryl; and
X⁺ is H⁺ or a cation.

In some embodiments, the polyphenylene copolymer has a structure of Formula (VII):

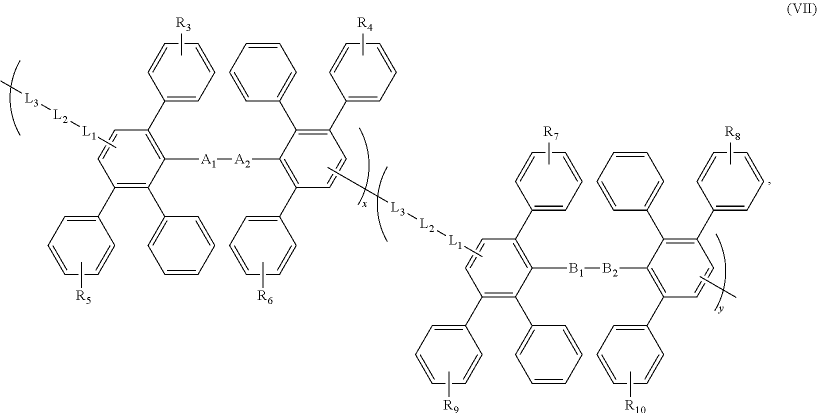

wherein:
R₃, R₄, R₅, and R₆ are each independently selected from H, SO₃⁻X⁺, PO₃²⁻2X⁺, and COO⁻X⁺;
R₇, R₈, R₉, and R₁₀ are each independently selected from H, C₁₋₆ alkyl, halo, nitro, and cyano;
A₁ and B₁ are each independently arylene, heteroarylene, aralkylene, or heteroaralkylene, wherein said arylene, heteroarylene, aralkylene, and heteroaralkylene are unsubstituted or substituted with 1, 2, 3, or 4 substituents independently selected from C₁₋₆ alkyl, halo, nitro, cyano, aryl, and heteroaryl; A₂ and B₂ are each independently absent, arylene, heteroarylene, aralkylene, or heteroaralkylene, wherein said arylene, heteroarylene, aralkylene, and heteroaralkylene are unsubstituted or substituted with 1, 2, 3, or 4 substituents independently selected from C₁₋₆ alkyl, halo, nitro, cyano, aryl, and heteroaryl;
L₁ are each independently an unsubstituted or substituted linking heteroatom, arylene, heteroarylene, aralkylene, or heteroaralkylene, wherein said arylene, heteroarylene, aralkylene, and heteroaralkylene are unsubstituted or substituted with 1, 2, 3, or 4 substituents independently selected from C₁₋₆ alkyl, halo, nitro, cyano, aryl, and heteroaryl;
L₂ and L₃ are each independently absent, arylene, or heteroarylene, wherein said arylene and heteroarylene are unsubstituted or substituted with 1, 2, 3, or 4 substituents independently selected from C₁₋₆ alkyl, halo, nitro, cyano, aryl, and heteroaryl; and
X⁺ is H⁺ or a cation.

In some embodiments, the sulfonated polyphenylene polymer or the sulfonated polyphenylene copolymer is linear, branched, or hyperbranched.

Sulfonated polyphenylene polymers of the present disclosure can be branched and/or hypethranched. Without being bound by theory, in some embodiments, branched and/or hypethranched polyphenylene polymers can have different or improved properties over the linear polymer analogues. Branched and/or hyperbranched polyphenylene polymers can comprise a branching unit (M₁), which is covalently bound to at least three repeat units. In some embodiments, M₁ is covalently bound to 3 repeat units. In some embodiments, M₁ is covalently bound to 4 repeat units. In some embodiments, M₁ is covalently bound to 5 repeat units. In some embodiments, M₁ is covalently bound to 6 repeat units. The branching unit (M₁) can be introduced through a compound of Formula (VIII).

In some embodiments, the method further comprises polymerizing with a triethynyl arene of Formula (VIII). In some embodiments, the polymerizing with a triethynyl arene of Formula (VIII) forms a branched or hyperbranched structure. In some embodiments, Formula (VIII) has the structure:

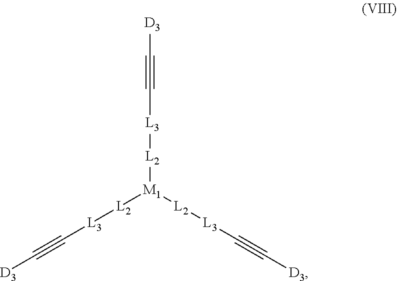

wherein
D₃ are each independently H, R_{1G}, or R_{1H}, and
M₁ is an unsubstituted or substituted linking atom, arylene, heteroarylene, aralkylene, or heteroaralkylene, wherein the arylene, heteroarylene, aralkylene, and heteroaralkylene are each unsubstituted or substituted with 1, 2, or 3 substituents independently selected from C₁₋₆ alkyl, halo, nitro, cyano, aryl, and heteroaryl.

In some embodiments, Formula (VIII) is selected from the group consisting of:

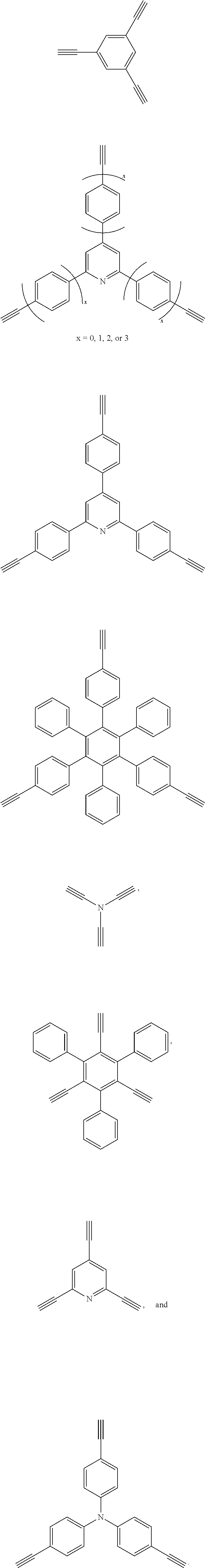

In some embodiments, Formula (VIII) is

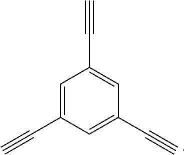

In some embodiments, the branching unit (M₁) can be bound to five or six groups. For example, M₁ can comprise five or six functionalized aromatic rings, to comprise hexa- or penta-phenylbenzene dienophile derivatives. Representative hexa- or penta-phenylbenzene dienophiles can include the following, wherein the “R” substituents can be the same or can be different within the compound, and can comprise an alkyne functional or a hydrogen:

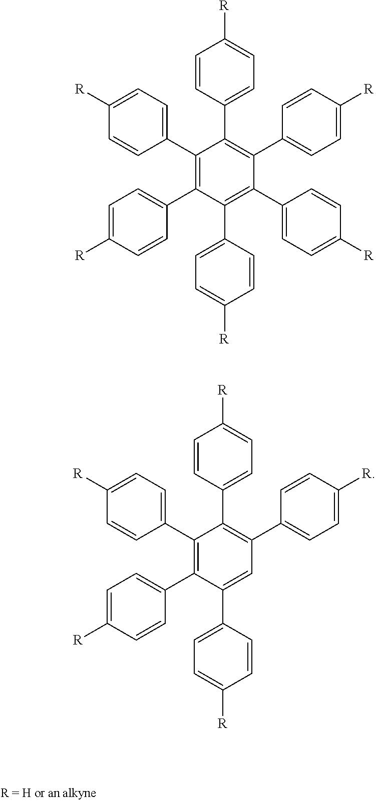

In some embodiments, M₁ is covalently bound to 5 or 6 repeat units. For example, the dienophile can be

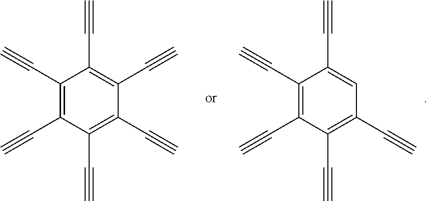

In some embodiments, M₁ is bound through a covalent bond to at least 3 repeat units. In some embodiments, M₁ is selected from the group consisting of:

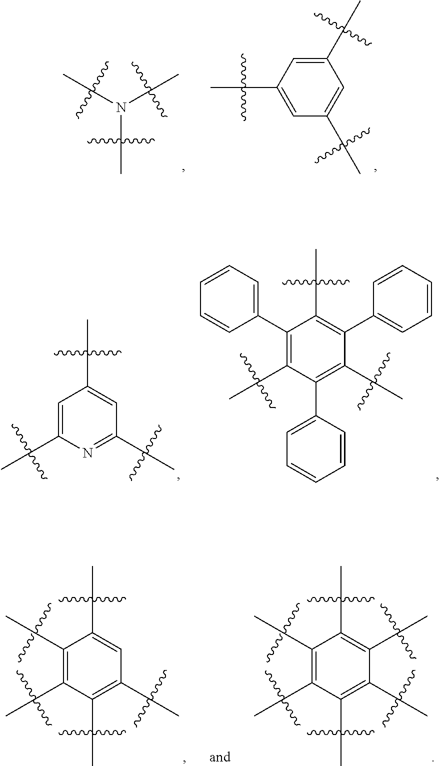

In some embodiments, M₁ is

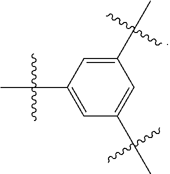 [SMILES: *c1cc(*)cc(*)c1]

In some embodiments, M₁ is phenyl, L₂ is p-phenyl, and L₃ is absent, to form compound having the following structure:

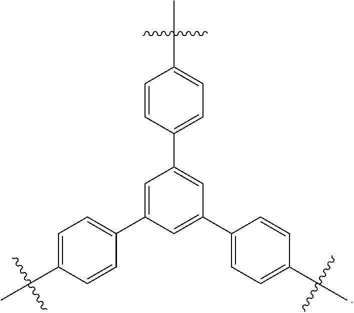 [SMILES: *c1ccc(-c2cc(-c3ccc(*)cc3)cc(-c3ccc(*)cc3)c2)cc1]

In some embodiments, the branched or hypethranched polymer has a structure of Formula (IX):

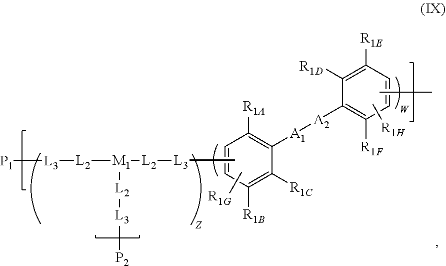

wherein P₁ and P₂ are independently selected from a repeat unit (x) of Formula (III) and a repeat unit (y) of Formula (V);
M₁ is an unsubstituted or substituted linking atom, arylene, heteroarylene, aralkylene, or heteroaralkylene, wherein the arylene, heteroarylene, aralkylene, and heteroaralkylene are unsubstituted or substituted with 1, 2, or 3 substituents independently selected from C₁₋₆ alkyl, halo, nitro, cyano, aryl, and heteroaryl;
L₂ and L₃ are each independently absent, arylene, or heteroarylene, wherein said arylene and heteroarylene are unsubstituted or substituted with 1, 2, 3, or 4 substituents independently selected from C₁₋₆ alkyl, halo, nitro, cyano, aryl, and heteroaryl;
A₁ is arylene, heteroarylene, aralkylene, or heteroaralkylene, wherein said arylene, heteroarylene, aralkylene, and heteroaralkylene are unsubstituted or substituted with 1, 2, 3, or 4 substituents independently selected from halo, nitro, cyano, aryl, and heteroaryl;
A₂ is absent, arylene, or heteroarylene, wherein said arylene and heteroarylene are unsubstituted or substituted with 1, 2, 3, or 4 substituents independently selected from halo, nitro, cyano, aryl, and heteroaryl;
R_{1A}, R_{1B}, R_{1C}, R_{1D}, R_{1E}, and R_{1F} are independently aryl or heteroaryl, each unsubstituted or substituted with 1, 2, 3, 4, or 5 substituents independently selected from C₁ alkyl, halo, SO₃⁻X⁺, PO₃²⁻2X⁺, and COO⁻X⁺, and provided that at least two of R_{1A}, R_{1B}, R_{1C}, R_{1D}, R_{1E}, and R_{1F} are independently aryl or heteroaryl substituted with 1, 2, 3, 4, or 5 substituents independently selected from SO₃⁻X⁺, PO₃²⁻2X⁺, and COO⁻X⁺;
R_{1G} and R_{1H} are independently H, aryl, or heteroaryl, wherein the aryl and heteroaryl are unsubstituted or substituted with 1, 2, 3, 4, or 5 substituents independently selected from C₁₋₆ alkyl, halo, nitro, cyano, SO₃⁻X⁺, PO₃²⁻2X⁺, and COO⁻X⁺; and
X⁺ is H⁺ or a cation.

In some embodiments, the sulfonated polyphenylene polymer or sulfonated polyphenylene copolymer has a structure of Formula (X):

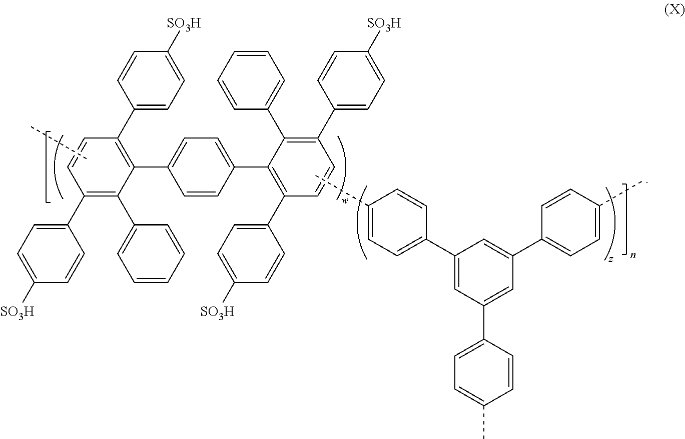

In some embodiments, a ratio of z:w is greater than 0.2. In some embodiments, the ratio of z:w is from about 1:3 to about 1:2. In some embodiments, the ratio of z:w is from about 1:4 to about 2:3. In some embodiments, the ratio of z:w is from about 1:5 to about 3:4. In some embodiments, the ratio of z:w is about 1:2. In some embodiments, the ratio of z:w is about 2:3. In some embodiments, a ratio of z:w is about 0.67.

The relative molar composition of z:w can influence the extent of branching and the structural, material, and electronic properties of the resulting polymer. As such, for values of a molar ratio less than about 1:3 or greater than about 1:2, or less than about 1:3 or greater than about 2:3, or less than about 1:4 or greater than about 1:2, the extent of branching can be too low or too high, respectively, for the polymer to exhibit desired ionomeric performance.

In some embodiments, the branched and/or hypethranched sulfonated polyphenylene polymer is prepared by polymerizing an amount of each of the sulfonated bis-cyclopentadienone of Formula (I), the diethynyl arene of Formula (II), and the triethynyl arene of Formula (VIII).

Scheme 1: Synthesis of a branched sulfonated polyphenylene polymer and exemplary sulfonated polyphenylene polymer polymerized from the triethynyl arene of Formula (VIII) to produce branching among segments of the bifunctional repeat unit from Formula (I) and diethynyl arene of Formula (II).

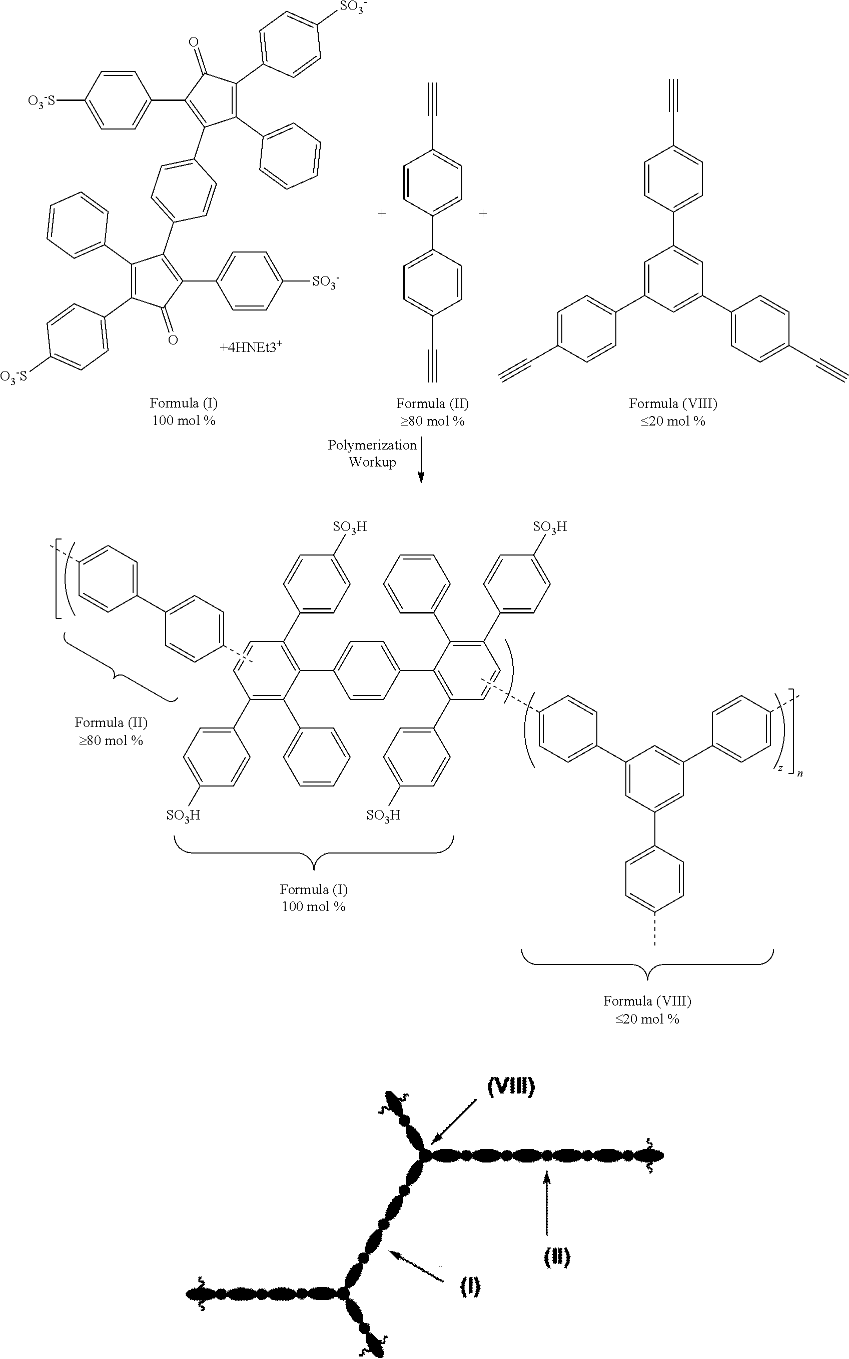

Scheme 2: Synthesis of a hypethranched sulfonated polyphenylene polymer and exemplary sulfonated polyphenylene polymer comprising the triethynyl arene of Formula (VIII) to effect branching, with few or no linear segments. Scheme 2 can omit the diethynyl arene of Formula (II) from above, or can include the diethynyl arene of Formula (II).

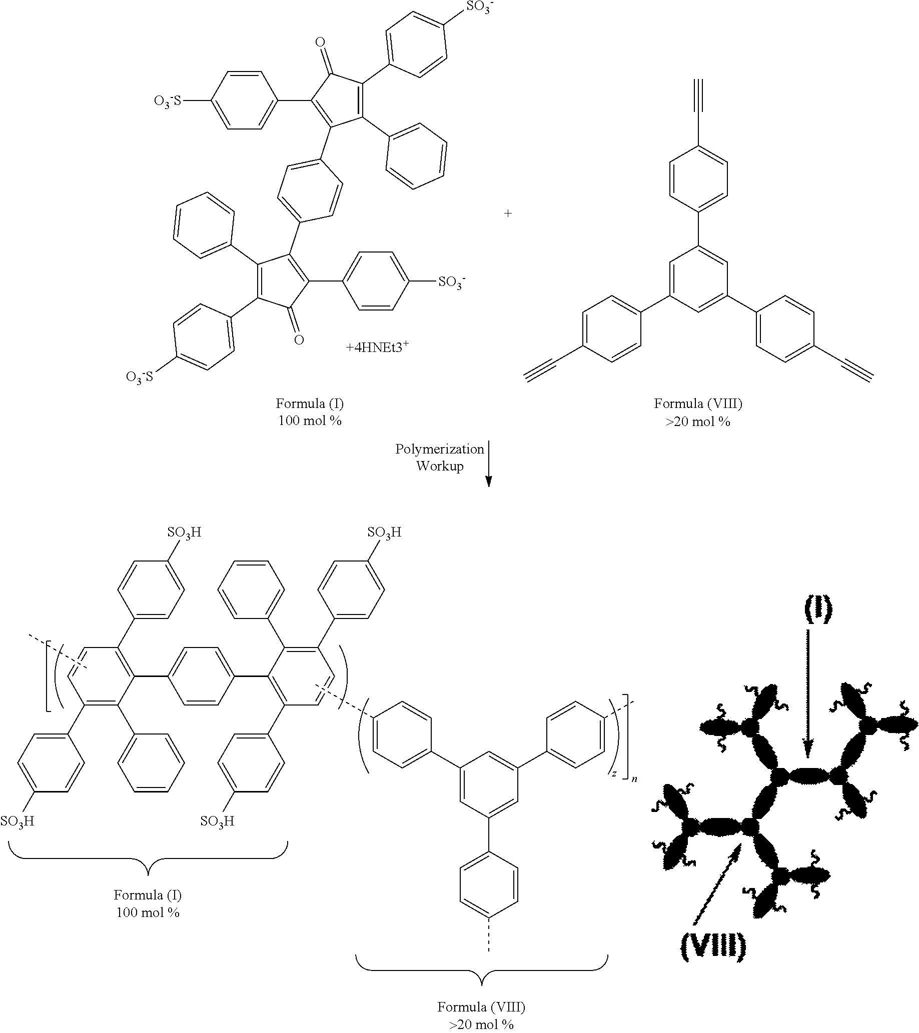

The polymers shown in Schemes 1 and/or 2 can additionally comprise the hydrophobic polyphenylene copolymer repeat unit of Formula (V) to form a branched or hyperbranched sulfonated polyphenylene copolymer, respectively.

In some embodiments, the branched and/or hypethranched sulfonated polyphenylene polymer is prepared by polymerizing an amount of each of the sulfonated bis-cyclopentadienone of Formula (I), the diethynyl arene of Formula (II), and the triethynyl arene of Formula (VIII). For example, such method is shown in Schemes 1 and 2.

In some embodiments, the branched and/or hypethranched sulfonated polyphenylene copolymer is prepared by polymerizing an amount of each of the sulfonated bis-cyclopentanedienone of Formula (I), the bis-cyclopentanedienone of Formula (IV), the diethynyl arene of Formula (II), and the triethynyl arene of Formula (VIII).

In some embodiments disclosed herein, R_{1A}, R_{1B}, R_{1C}, R_{1D}, R_{1E}, and RIF are each independently aryl.

In some embodiments, the aryl of R_{1A}, R_{1B}, R_{1C}, R_{1D}, R_{1E}, and R_{1F} is unsubstituted. In some embodiments, the aryl of R_{1A}, R_{1B}, R_{1C}, R_{1D}, R_{1E}, and R_{1F} is substituted with 1, 2, 3, 4, or 5 substituents each independently selected from C₁₋₆ alkyl, halo, nitro, cyano, SO₃⁻X⁺, PO₃²⁻2X⁺, and COO⁻X⁺. In some embodiments, the aryl of R_{1A}, R_{1B}, R_{1C}, R_{1D}, R_{1E}, and R_{1F} is substituted with 1, 2, 3, 4, or 5 substituents each independently selected from C₁₋₆ alkyl, halo, SO₃⁻X⁺, PO₃²⁻2X⁺, and COO⁻X⁺. In some embodiments, the aryl of R_{1A}, R_{1B}, R_{1C}, R_{1D}, R_{1E}, and R_{1F} is substituted with 1, 2, 3, 4, or 5 substituents each independently selected from C₁₋₆ alkyl, halo, and SO₃⁻X⁺. In some embodiments, the aryl of R_{1A}, R_{1B}, R_{1C}, R_{1D}, R_{1E}, and R_{1F} is substituted with 1, 2, 3, 4, or 5 SO₃⁻X⁺. In some embodiments, the aryl of one or more of R_{1A}, R_{1B}, R_{1C}, R_{1D}, R_{1E}, and R_{1F} is substituted with SO₃⁻X⁺. In some embodiments, at least two of R_{1A}, R_{1B}, R_{1C}, R_{1D}, R_{1E}, and R_{1F} are independently aryl substituted with 1, 2, 3, 4, or 5 SO₃⁻X⁺. In some embodiments, four of R_{1A}, R_{1B}, R_{1C}, R_{1D}, R_{1E}, and R_{1F} are aryl substituted with 1 SO₃⁻X⁺.

In some embodiments disclosed herein, R_{1A}, R_{1B}, R_{1C}, R_{1D}, R_{1E}, and RIF are each independently heteroaryl.

In some embodiments, the heteroaryl of R_{1A}, R_{1B}, R_{1C}, R_{1D}, R_{1E}, and RIF is unsubstituted. In some embodiments, the heteroaryl of R_{1A}, R_{1B}, R_{1C}, R_{1D}, R_{1E}, and R_{1F} is substituted with 1, 2, 3, 4, or 5 substituents each independently selected from C₁₋₆ alkyl, halo, nitro, cyano, SO₃⁻X⁺, PO₃²⁻2X⁺, and COO⁻X⁺. In some embodiments, the heteroaryl of R_{1A}, R_{1B}, R_{1C}, R_{1D}, R_{1E}, and R_{1F} is substituted with 1, 2, 3, 4, or 5 substituents each independently selected from C₁₋₆ alkyl, halo, SO₃⁻X⁺, PO₃²⁻2X⁺, and COO⁻X⁺. In some embodiments, the heteroaryl of R_{1A}, R_{1B}, R_{1C}, R_{1D}, R_{1E}, and R_{1F} is substituted with 1, 2, 3, 4, or 5 substituents each independently selected from C₁₋₆ alkyl, halo, and SO₃⁻X⁺. In some embodiments, the heteroaryl of R_{1A}, R_{1B}, R_{1C}, R_{1D}, R_{1E}, and R_{1F} is substituted with 1, 2, 3, 4, or 5 SO₃⁻X⁺. In some embodiments, the heteroaryl of one or more of R_{1A}, R_{1B}, R_{1C}, R_{1D}, R_{1E}, and R_{1F} is substituted with SO₃⁻X⁺. In some embodiments, at least two of R_{1A}, R_{1B}, R_{1C}, R_{1D}, R_{1E}, and R_{1F} are independently heteroaryl substituted with 1, 2, 3, 4, or 5 SO₃⁻X⁺. In some embodiments, four of R_{1A}, R_{1B}, R_{1C}, R_{1D}, R_{1E}, and R_{1F} are heteroaryl substituted with 1 SO₃⁻X⁺.

In some embodiments, R_{3A}, R_{3B}, R_{3C}, R_{3D}, R_{3E}, and R_{3F} are each independently aryl. In some embodiments, the aryl of R_{3A}, R_{3B}, R_{3C}, R_{3D}, R_{3E}, and R_{3F} is unsubstituted. In some embodiments, the aryl of R_{3A}, R_{3B}, R_{3C}, R_{3D}, R_{3E}, and R_{3F} is substituted with 1, 2, 3, 4, or 5 substituents each independently selected from C₁₋₆ alkyl, halo, nitro, and cyano. In some embodiments, the aryl of R_{3A}, R_{3B}, R_{3C}, R_{3D}, R_{3E}, and R_{3F} is substituted with 1, 2, 3, 4, or 5 substituents each independently selected from C₁₋₆ alkyl and halo.

In some embodiments, R_{3A}, R_{3B}, R_{3C}, R_{3D}, R_{3E}, and R_{3F} are each independently heteroaryl. In some embodiments, the heteroaryl of R_{3A}, R_{3B}, R_{3C}, R_{3D}, R_{3E}, and R_{3F} is unsubstituted. In some embodiments, the heteroaryl of R_{3A}, R_{3B}, R_{3C}, R_{3D}, R_{3E}, and R_{3F} is substituted with 1, 2, 3, 4, or 5 substituents each independently selected from C₁₋₆ alkyl, halo, nitro, and cyano. In some embodiments, the heteroaryl of R_{3A}, R_{3B}, R_{3C}, R_{3D}, R_{3E}, and R_{3F} is substituted with 1, 2, 3, 4, or 5 substituents each independently selected from C₁₋₆ alkyl and halo.

In some embodiments, R_{1G} and R_{1H} are each independently H.

In some embodiments, R_{1G} and R_{1H} are independently aryl. In some embodiments, R_{1G} and R_{1H} are independently unsubstituted aryl. In some embodiments, R_{1G} and R_{1H} are independently aryl substituted with 1, 2, 3, 4, or 5 substituents independently selected from C₁₋₆ alkyl, halo, nitro, cyano, SO₃⁻X⁺, PO₃²⁻2X⁺, and COO⁻X⁺. In some embodiments, R_{1G} and R_{1H} are independently aryl substituted with SO₃⁻X⁺.

In some embodiments, R_{1G} and R_{1H} are independently heteroaryl. In some embodiments, R_{1G} and R_{1H} are independently unsubstituted heteroaryl. In some embodiments, R_{1G} and R_{1H} are independently heteroaryl substituted with 1, 2, 3, 4, or 5 substituents independently selected from C₁₋₆ alkyl, halo, nitro, cyano, SO₃⁻X⁺, P₃²⁻2X⁺, and COO⁻X⁺. In some embodiments, R_{1G} and R_{1H} are independently heteroaryl substituted with SO₃⁻X⁺.

In some embodiments, A₁ is arylene. In some embodiments, A₁ is phenylene.

In some embodiments, A₁ is heteroarylene. In some embodiments, A₁ is aralkylene. In some embodiments, A₁ is heteroaralkylene.

In some embodiments, the arylene, heteroarylene, aralkylene, and heteroaralkylene of A₁ is unsubstituted. In some embodiments, A₁ is arylene, heteroarylene, aralkylene, or heteroaralkylene substituted with 1, 2, 3, or 4 substituents independently selected from halo, nitro, cyano, aryl, and heteroaryl. In some embodiments, A₁ is unsubstituted arylene. In some embodiments, A₁ is arylene substituted with 1, 2, 3, or 4 substituents independently selected from halo, nitro, cyano, aryl, and heteroaryl. In some embodiments, A₁ is unsubstituted phenylene. In some embodiments, A₁ is phenylene substituted with 1, 2, 3, or 4 substituents independently selected from halo, nitro, cyano, aryl, and heteroaryl.

In some embodiments, A₂ is absent.

In some embodiments, A₂ is unsubstituted arylene. In some embodiments, A₂ is arylene substituted with 1, 2, 3, or 4 substituents independently selected from halo, nitro, cyano, aryl, and heteroaryl. In some embodiments, A₂ is unsubstituted phenylene. In some embodiments, A₂ is phenylene substituted with 1, 2, 3, or 4 substituents independently selected from halo, nitro, cyano, aryl, and heteroaryl.

In some embodiments, A₂ is unsubstituted heteroarylene. In some embodiments, A₂ is heteroarylene substituted with 1, 2, 3, or 4 substituents independently selected from halo, nitro, cyano, aryl, and heteroaryl.

In some embodiments, B₁ is arylene. In some embodiments, B₁ is phenylene.

In some embodiments, B₁ is heteroarylene. In some embodiments, B₁ is aralkylene. In some embodiments, B₁ is heteroaralkylene.

In some embodiments, the arylene, heteroarylene, aralkylene, and heteroaralkylene of B 1 is unsubstituted. In some embodiments, B 1 is arylene, heteroarylene, aralkylene, or heteroaralkylene substituted with 1, 2, 3, or 4 substituents independently selected from halo, nitro, cyano, aryl, and heteroaryl. In some embodiments, B, is unsubstituted arylene. In some embodiments, B, is arylene substituted with 1, 2, 3, or 4 substituents independently selected from halo, nitro, cyano, aryl, and heteroaryl. In some embodiments, B₁ is unsubstituted phenylene. In some embodiments, B₁ is phenylene substituted with 1, 2, 3, or 4 substituents independently selected from halo, nitro, cyano, aryl, and heteroaryl.

In some embodiments, B₂ is absent.

In some embodiments, B₂ is unsubstituted arylene. In some embodiments, B₂ is arylene substituted with 1, 2, 3, or 4 substituents independently selected from halo, nitro, cyano, aryl, and heteroaryl. In some embodiments, B₂ is unsubstituted phenylene. In some embodiments, B₂ is phenylene substituted with 1, 2, 3, or 4 substituents independently selected from halo, nitro, cyano, aryl, and heteroaryl.

In some embodiments, B₂ is unsubstituted heteroarylene. In some embodiments, B₂ is heteroarylene substituted with 1, 2, 3, or 4 substituents independently selected from halo, nitro, cyano, aryl, and heteroaryl.

In some embodiments, L₁ is a linking heteroatom. For example, L₁ can be nitrogen or carbon. In some embodiments, the linking heteroatom of L₁ is unsubstituted. In some embodiments, the linking heteroatom of L₁ is substituted.

In some embodiments, L₁ is arylene. In some embodiments, L₁ is phenylene. In some embodiments, L₁ is naphthalenylene.

In some embodiments, L₁ is heteroarylene. In some embodiments, L₁ is aralkylene. In some embodiments, L₁ is heteroaralkylene.

In some embodiments, the arylene, heteroarylene, aralkylene, and heteroaralkylene of L₁ is unsubstituted. In some embodiments, L₁ is arylene, heteroarylene, aralkylene, or heteroaralkylene substituted with 1, 2, 3, or 4 substituents independently selected from C₁₋₆ alkyl, halo, nitro, cyano, aryl, and heteroaryl. In some embodiments, L₁ is unsubstituted arylene. In some embodiments, L₁ is arylene substituted with 1, 2, 3, or 4 substituents independently selected from C₁₋₆ alkyl, halo, nitro, cyano, aryl, and heteroaryl. In some embodiments, L₁ is unsubstituted phenylene. In some embodiments, L₁ is phenylene substituted with 1, 2, 3, or 4 substituents independently selected from C₁₋₆ alkyl, halo, nitro, cyano, aryl, and heteroaryl. In some embodiments, L₁ is C₁₋₆ alkyl-substituted phenylene. In some embodiments, L₁ is unsubstituted naphthalenylene. In some embodiments, L₁ is naphthalenylene substituted with 1, 2, 3, or 4 substituents independently selected from C₁₋₆ alkyl, halo, nitro, cyano, aryl, and heteroaryl.

In some embodiments, L₂ and L₃ are both absent.

In some embodiments, L₂ is absent.

In some embodiments, L₂ is unsubstituted arylene. In some embodiments, L₂ is arylene substituted with 1, 2, 3, or 4 substituents independently selected from C₁₋₆ alkyl, halo, nitro, cyano, aryl, and heteroaryl. In some embodiments, L₂ is unsubstituted phenylene. In some embodiments, L₂ is phenylene substituted with 1, 2, 3, or 4 substituents independently selected from C₁₋₆ alkyl, halo, nitro, cyano, aryl, and heteroaryl. In some embodiments, L₂ is phenylene substituted with 1, 2, 3, or 4 substituents each independently selected from C₁₋₆ alkyl and halo.

In some embodiments, L₃ is absent.

In some embodiments, L₃ is unsubstituted arylene. In some embodiments, L₃ is arylene substituted with 1, 2, 3, or 4 substituents independently selected from C₁₋₆ alkyl, halo, nitro, cyano, aryl, and heteroaryl. In some embodiments, L₃ is unsubstituted phenylene. In some embodiments, L₃ is phenylene substituted with 1, 2, 3, or 4 substituents independently selected from C₁₋₆ alkyl, halo, nitro, cyano, aryl, and heteroaryl. In some embodiments, L₃ is phenylene substituted with 1, 2, 3, or 4 substituents each independently selected from C₁₋₆ alkyl and halo.

In some embodiments, L₁ of Formula (III) is the same as L₁ of Formula (V).

In some embodiments, L₁ of Formula (III) is different from L₁ of Formula (V).

In some embodiments, L₂ of Formula (III) is the same as L₂ of Formula (V).

In some embodiments, L₂ of Formula (III) is different from L₂ of Formula (V).

In some embodiments, L₃ of Formula (III) is the same as L₃ of Formula (V).

In some embodiments, L₃ of Formula (III) is different from L₃ of Formula (V).

In some embodiments, each L₃, L₂, and L₁ of -L₃-L₂-L₁-, and each L₃ and L₂, of -L₃-L₂-M₁-, when present, are independently selected from the group consisting of:

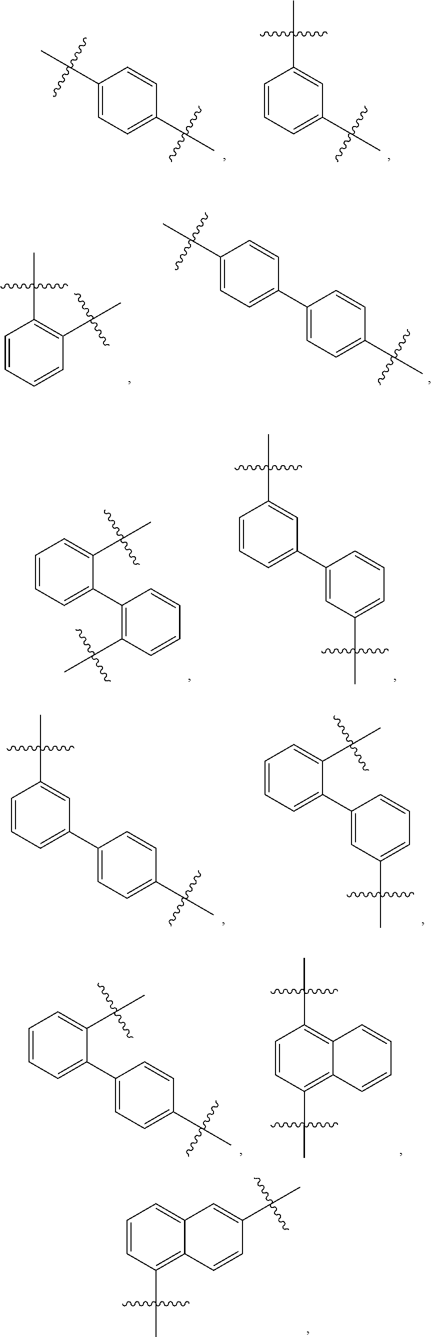

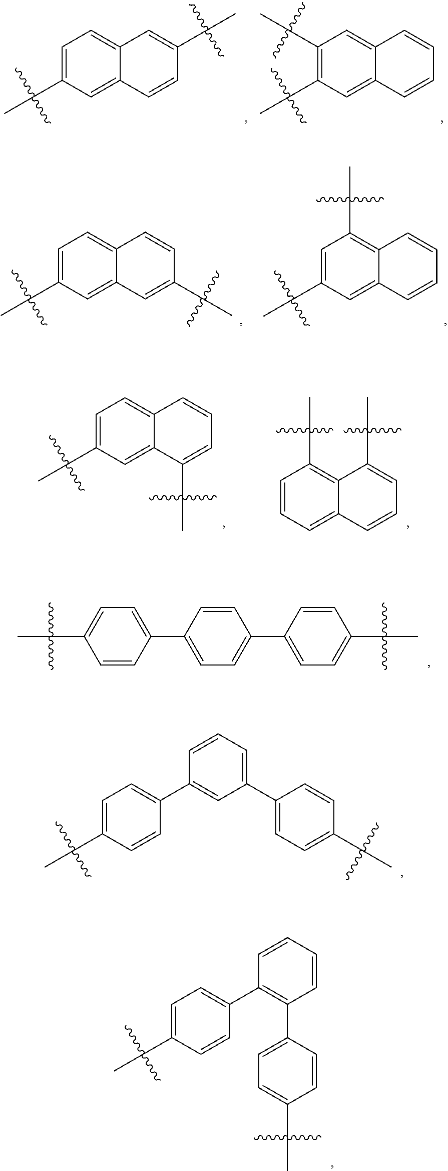

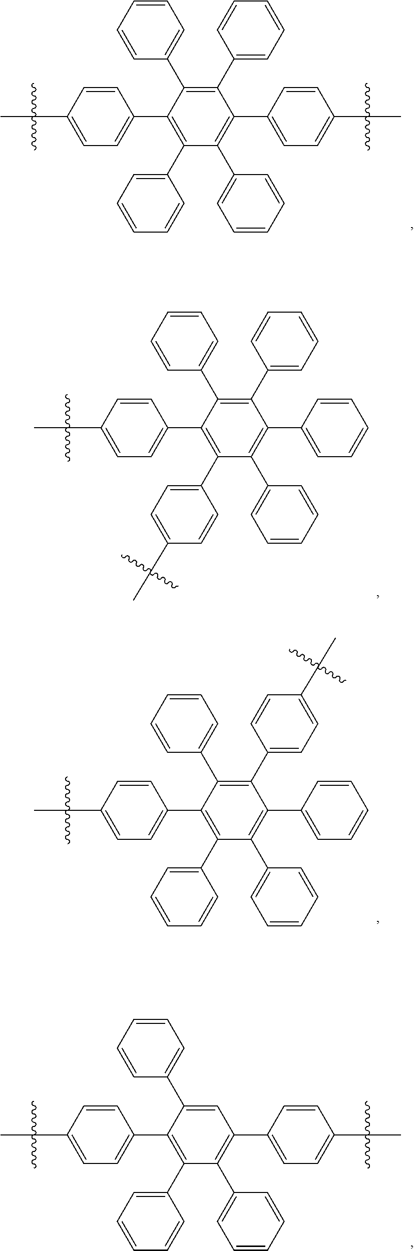 [SMILES: *c1ccc(-c2c(-c3ccccc3)c(-c3ccccc3)c(-c3ccc(*)cc3)c(-c3ccccc3)c2-c2ccccc2)cc1 ; *c1ccc(-c2c(-c3ccccc3)c(-c3ccccc3)c(-c3ccccc3)c(-c3ccccc3)c2-c2ccc(*)cc2)cc1 ; *c1ccc(-c2c(-c3ccccc3)c(-c3ccccc3)c(-c3ccccc3)c(-c3ccc(*)cc3)c2-c2ccccc2)cc1 ; *c1ccc(-c2cc(-c3ccccc3)c(-c3ccc(*)cc3)c(-c3ccccc3)c2-c2ccccc2)cc1]

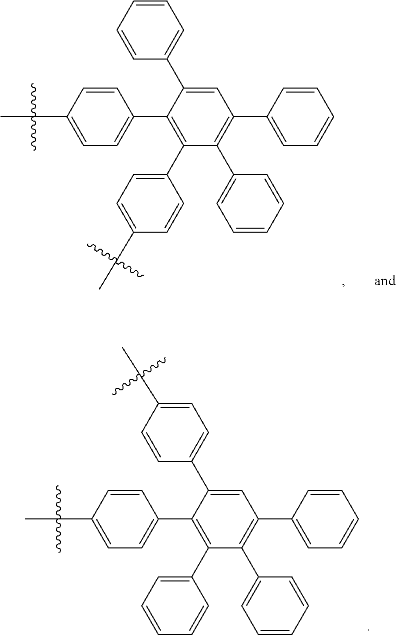 [SMILES: *c1ccc(-c2c(-c3ccccc3)cc(-c3ccccc3)c(-c3ccccc3)c2-c2ccc(*)cc2)cc1 ; *c1ccc(-c2cc(-c3ccccc3)c(-c3ccccc3)c(-c3ccccc3)c2-c2ccc(*)cc2)cc1]

In some embodiments, the repeat unit of Formula (III) is a repeat unit of Formula (III-A):

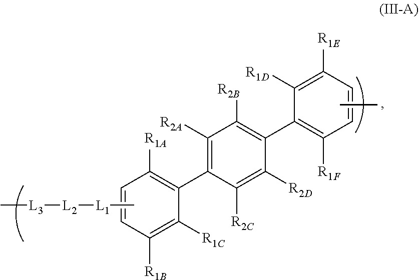

wherein R_{1A}, R_{1B}, R_{1C}, R_{1D}, R_{1E}, R_{1F}, L₁, L₂, and L₃ are as described herein; and
R_{2A}, R_{2B}, R_{2C}, and R_{2D} are independently H, halo, nitro, cyano, aryl, or heteroaryl.

In some embodiments, the sulfonated polyphenylene polymer repeat unit (x) of Formula (III) is selected from the group consisting of:

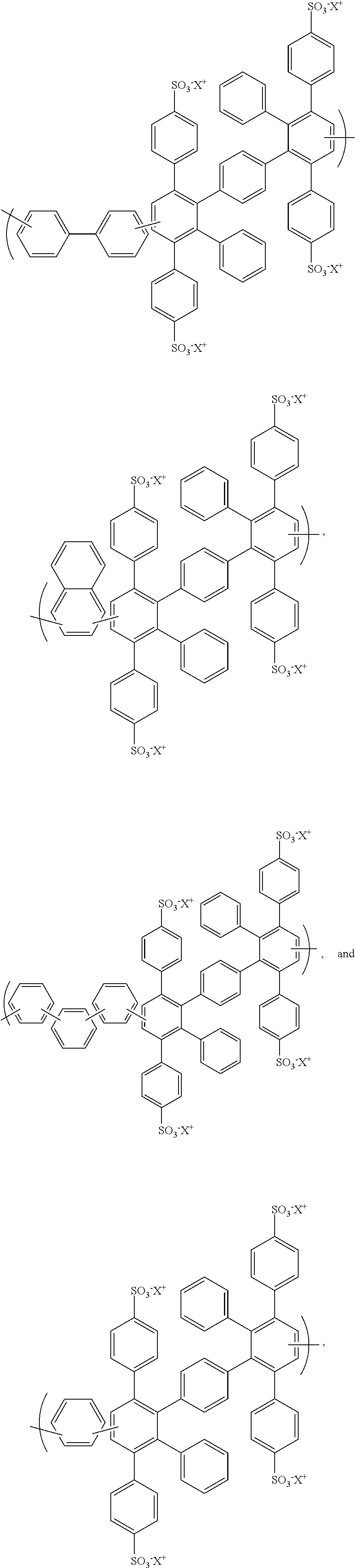

In some embodiments, the sulfonated polyphenylene polymer repeat unit (x) of Formula (III) is selected from the group consisting of:

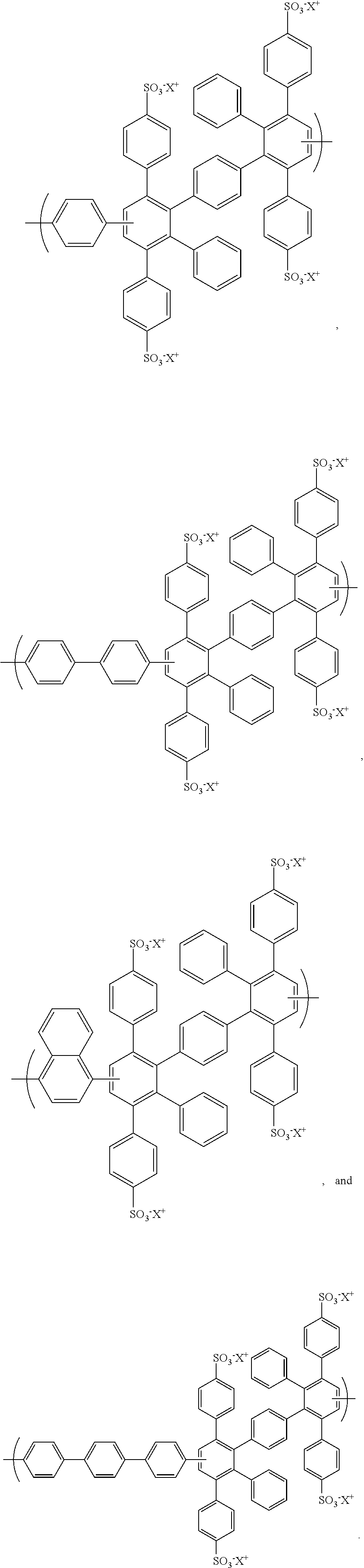

In some embodiments, the hydrophobic polyphenylene repeat unit of Formula (V) is a repeat unit of Formula (V-A):

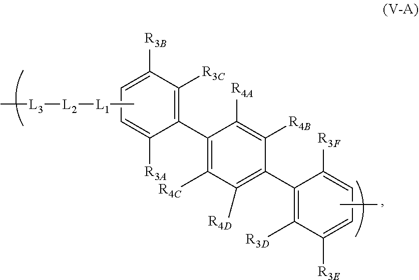

wherein R_{3A}, R_{3B}, R_{3C}, R_{3D}, R_{3E}, R_{3F}, L₁, L₂, and L₃ are as described herein; and
R_{4A}, R_{4B}, R_{4C}, and R_{4D} are independently H, halo, nitro, cyano, aryl, or heteroaryl.

In some embodiments, the hydrophobic polyphenylene repeat unit (y) of Formula (V) is selected from the group consisting of:

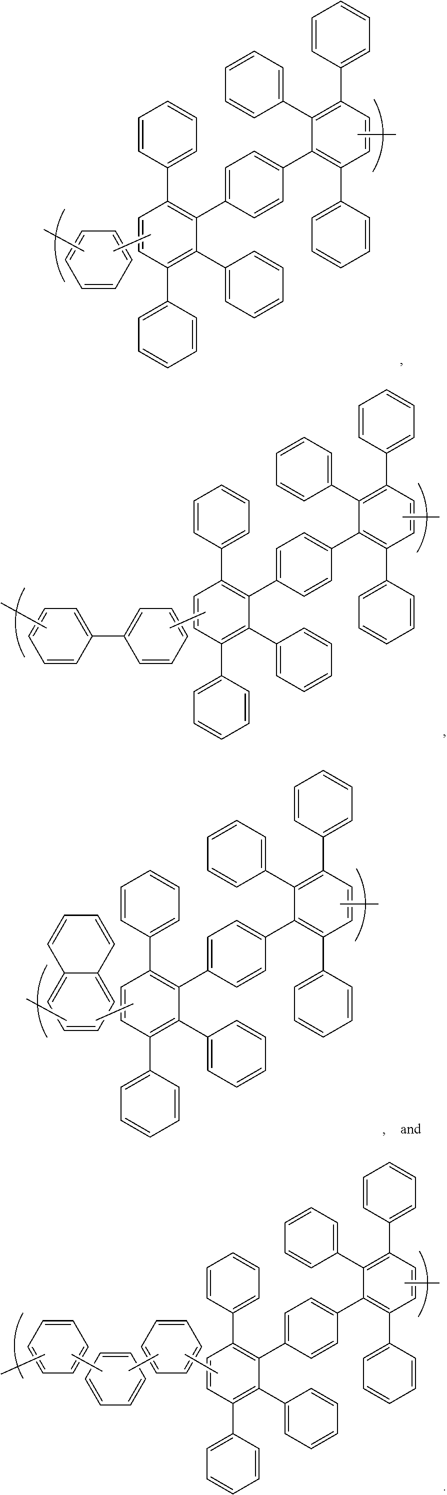

In some embodiments, the hydrophobic polyphenylene repeat unit (y) of Formula (V) is selected from the group consisting of:

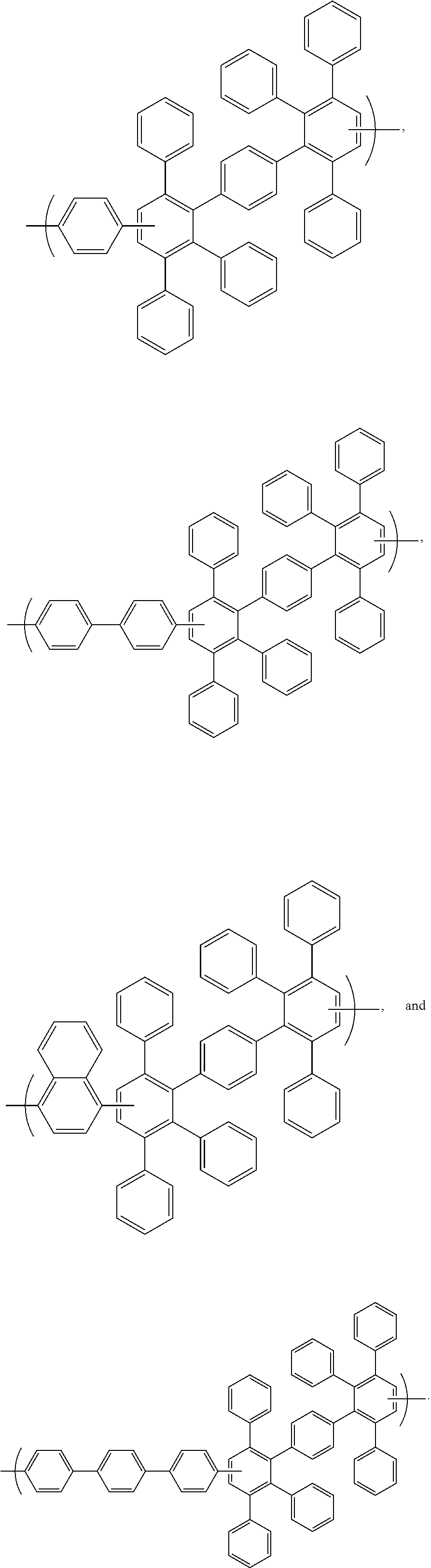

In some embodiments, the polymerizing comprises about a 59-99 mole % of the sulfonated bis-cyclopentadienone of Formula (I) and about 41-1 mole % of the bis-cyclopentadienone of Formula (IV). In some embodiments, the polymerizing comprises about a 85-99 mole % of the sulfonated bis-cyclopentadienone Formula (I) and about 15-1 mole % of the bis-cyclopentadienone Formula (IV).

In some embodiments, the polymerizing comprises about a 90:10 ratio of the sulfonated bis-cyclopentadienone of Formula (I) to the bis-cyclopentadienone of Formula (IV).

In some embodiments, the mole percent of (x) is about 59% to about 99%, and the mole percent of (y) is about 41% to about 1%. In some embodiments, the mole percent of (x) is about 85% to about 99%, and the mole percent of (y) is about 15% to about 1%.

In some embodiments, the mole percent of (x) is about 90%, and the mole percent of (y) is about 10%.

In some embodiments, the sulfonated polyphenylene copolymer is a random copolymer comprising a random distribution of Formula (III) and Formula (V). In some embodiments, a mole ratio of the sulfonated polyphenylene polymer repeat unit (x) of Formula (III) to the hydrophobic polyphenylene repeat unit (y) of Formula (V) ranges from about 1:99 to about 99:1. In some embodiments, a mole ratio of the sulfonated polyphenylene polymer repeat unit (x) of Formula (III) to the hydrophobic polyphenylene repeat unit (y) of Formula (V) ranges from about 59:41 to about 99:1. In some embodiments, a mole ratio of the sulfonated polyphenylene polymer repeat unit (x) of Formula (III) to the hydrophobic polyphenylene repeat unit (y) of Formula (V) ranges from about 85:15 to about 99:1. In some embodiments, a mole ratio of the sulfonated polyphenylene polymer repeat unit (x) of Formula (III) to the hydrophobic polyphenylene repeat unit (y) of Formula (V) is about 90:10.

In some embodiments, the sulfonated polyphenylene copolymer is a statistical copolymer comprising an average composition ratio of the repeat unit (x) of Formula (III) and repeat unit (y) of Formula (V). In some embodiments, the statistical copolymer average composition of the repeat unit (x) of Formula (III) is about 59 mole % to about 99 mole %, and the statistical copolymer average composition to the repeat unit (y) of Formula (V) is about 41% to about 1%. In some embodiments, the statistical copolymer average composition ratio of the repeat unit (x) of Formula (III) to the repeat unit (y) of Formula (V) is 90:10.

In some embodiments, the sulfonated polyphenylene copolymer is a random block copolymer. In some embodiments, the repeat unit (x) of Formula (III) of the random block copolymer is an integer from 3 to 100. In some embodiments, the repeat unit (y) of Formula (V) of the random block copolymer is an integer from 3 to 100. In some embodiments, a mole ratio of a first block to a second block ranges from about 1:99 to about 99:1.

The method described herein can produce repeat units having para arylene connectivity, meta arylene connectivity, or a combination of para and meta arylene connectivity. Likewise, the connectivity can be at one ring position of a heteroarylene group, at another ring position of a heteroarylene group, or at a combination of more than one ring position of a heteroarylene group.

In some embodiments, X⁺ is H⁺. In some embodiments, X⁺ is a cation. In some embodiments, X⁺ is an alkali metal ion. In some embodiments, X⁺ is [N(R_{A})(R_{B})(R(_{C})(R_{D})]⁺ wherein R_{A}, R_{B}, R_{C}, and R_{D} are independently H, C₁₋₆ alkyl, aryl, or heteroaryl. In some embodiments, X⁺ is a combination of any two or more of H⁺, a cation, an alkali metal ion, and [N(R_{A})(R_{B})(R_{C})(R_{D})]⁺ wherein R_{A}, R_{B}, R_{C}, and R_{D} are independently H, C₁₋₆ alkyl, aryl, or heteroaryl. In some embodiments, the cation of X⁺ is an alkali metal ion; [N(R_{A})(R_{B})(R_{C})(R_{D})]⁺ wherein R_{A}, R_{B}, R_{C}, and R_{D} are independently H, C₁₋₆ alkyl, aryl, or heteroaryl; or a combination thereof.

In some embodiments, the sulfonated polyphenylene polymer has a molecular weight of between about 100 kDa and about 5,000 kDa. In some embodiments, the sulfonated polyphenylene copolymer has a molecular weight of between about 100 kDa and about 5,000 kDa. In some embodiments, the branched sulfonated polyphenylene polymer has a molecular weight of between about 100 kDa and about 5,000 kDa. In some embodiments, the branched sulfonated polyphenylene copolymer has a molecular weight of between about 100 kDa and about 5,000 kDa. In some embodiments, the hyperbranched sulfonated polyphenylene polymer has a molecular weight of between about 100 kDa and about 5,000 kDa. In some embodiments, the hyperbranched sulfonated polyphenylene copolymer has a molecular weight of between about 100 kDa and about 5,000 kDa.

In some embodiments, the sulfonated polyphenylene polymer has a molecular weight of between about 100 kDa and about 1,000 kDa. In some embodiments, the sulfonated polyphenylene copolymer has a molecular weight of between about 100 kDa and about 1,000 kDa. In some embodiments, the branched sulfonated polyphenylene polymer has a molecular weight of between about 100 kDa and about 1,000 kDa. In some embodiments, the branched sulfonated polyphenylene copolymer has a molecular weight of between about 100 kDa and about 1,000 kDa. In some embodiments, the hyperbranched sulfonated polyphenylene polymer has a molecular weight of between about 100 kDa and about 1,000 kDa. In some embodiments, the hyperbranched sulfonated polyphenylene copolymer has a molecular weight of between about 100 kDa and about 1,000 kDa.

In some embodiments, the sulfonated polyphenylene polymer has a molecular weight of between about 1,000 kDa and about 5,000 kDa. In some embodiments, the sulfonated polyphenylene copolymer has a molecular weight of between about 1,000 kDa and about 5,000 kDa. In some embodiments, the branched sulfonated polyphenylene polymer has a molecular weight of between about 1,000 kDa and about 5,000 kDa. In some embodiments, the branched sulfonated polyphenylene copolymer has a molecular weight of between about 1,000 kDa and about 5,000 kDa. In some embodiments, the hyperbranched sulfonated polyphenylene polymer has a molecular weight of between about 1,000 kDa and about 5,000 kDa. In some embodiments, the hyperbranched sulfonated polyphenylene copolymer has a molecular weight of between about 1,000 kDa and about 5,000 kDa.

In some embodiments, the repeat units of Formula (III) can be different from each other. For example, when more than one compound of Formula (I) is polymerized with one or more compound of Formula (II), the repeat units of Formula (III) can be different. In another example, when one or more compound of Formula (I) is polymerized with more than one compound of Formula (II), the repeat units of Formula (III) can be different.

In the foregoing, some repeat units of Formula (III) can also be the same. In some embodiments, all repeat units of Formula (III) are the same, or essentially all repeat units of Formula (III) are the same.

In some embodiments, the repeat units of Formula (V) can be different from each other. For example, when more than one compound of Formula (IV) is polymerized with one or more compound of Formula (II), the repeat units of Formula (V) can be different. In another example, when one or more compound of Formula (IV) is polymerized with more than one compound of Formula (II), the repeat units of Formula (V) can be different.

In the foregoing, some repeat units of Formula (V) can also be the same. In some embodiments, all repeat units of Formula (V) are the same, or essentially all repeat units of Formula (V) are the same.

In some embodiments, the sulfonated polyphenylene polymer is soluble in the one or more solvent.

In some embodiments, the sulfonated polyphenylene copolymer is soluble in the one or more solvent.

In some embodiments, the branched sulfonated polyphenylene polymer is soluble in the one or more solvent.

In some embodiments, the branched sulfonated polyphenylene copolymer is soluble in the one or more solvent.

In some embodiments, the hyperbranched sulfonated polyphenylene polymer is soluble in the one or more solvent.

In some embodiments, the hyperbranched sulfonated polyphenylene copolymer is soluble in the one or more solvent.

In some embodiments, the one or more solvent is not nitrobenzene.

In some embodiments, each of the one or more solvents has a dielectric constant of at least about 3.6, a Hansen solubility parameter (δTotal) of 50 or less, a boiling point at atmospheric pressure between about 100° C. and about 600° C., or a combination thereof.

Solvents useful in the practice of the disclosed method have a boiling point, at atmospheric pressure, between about 100° C. to about 600° C. In some embodiments, the boiling point at atmospheric pressure is between about 130° C. to about 350° C. In some embodiments, the boiling point at atmospheric pressure is between about 130° C. to about 250° C. In some embodiments, the boiling point at atmospheric pressure is about 242° C.

Unless otherwise indicated, the terms “total Hansen solubility parameter,” “Hansen solubility parameter,” and “total Hansen parameter” have the same meaning. Hansen solubility parameters (also named reverse solvency principle) were developed by Charles Hansen to predict if one material will dissolve in another and form a solution. Hansen solubility parameters are based on the concept that “like dissolves like,” wherein one molecule is defined as being “like” another if it bonds to itself in a similar way. Each chemical molecule is given three Hansen parameters, each generally measured in Mpa^{0.5}: (1) δD, the energy from dispersion bonds between molecules; (2) SP, the energy from polar bonds between molecules; and (3) δH, the energy from hydrogen bonds between molecules. The “total Hansen solubility parameter” (ST) is defined as:

$$δ {T}^{2} = δ {D}^{2} + δ {P}^{2} + δ {H}^{2}$$

The concept of a total Hansen parameter is well understood by those skilled in the art. A detailed description of the derivation and theory is found in various references such as (1) A. F. M. Barton, “Handbook of Polymer-Liquid Interaction Parameters and Solubility Parameters,” CRC Press Inc. (1990) and (2) Solubility Parameter Values, Eric A. Grulke, Polymer Handbook, John Wiley and Sons, Inc. (1989).

The solvents used herein are typically liquid at room temperature (about 18-25° C.) and exhibit moderate to strong hydrogen bonding with atoms in the disclosed polymers. General examples include solvents which comprise ketone, amide, ester, and alcohol functional groups. Such solvents typically have a total Hansen solubility parameter of greater than about 18, and a total Hansen solubility parameter of up to about 50. In some embodiments, each of the one or more solvents has a Hansen solubility parameter (δTotal) of about 50 or less. In some embodiments, each of the one or more solvents has a Hansen solubility parameter (δTotal) of about 18 to about 36.

For example, ester, amide, alcohol, and ketone-containing solvents can have a total Hansen solubility parameter of about 20 to about 30. Solubility parameters and lists of solvents are described in the article “Solubility Parameters,” Harry Burrell, Interchemical Review, Vol. 14, Spring 1955, #1, pps. 3-16 and September 1955, #2, pps. 31-46.

In addition to the total Hansen solubility parameters recited, the solvents can also exhibit a disclosed dielectric constant. In some embodiments, the static dielectric constant is at least about 3.6. In some embodiments, the static dielectric constant is between about 3.6 and about 80. In some embodiments, the static dielectric constant is between about 20 and about 70. In some embodiments, the static dielectric constant is between about 30 and about 70. In some embodiments, the static dielectric constant is about 64-65. The values of dielectric constants and lists of solvents are described in the book, “Table of Dielectric Constants of Pure Liquids,” Arthur A. Maryott and Edgar R. Smith, National Bureau of Standards Circular 514, Issued Aug. 10, 1951.

In some embodiments, each solvent of the one or more solvents used in the disclosed method exhibits one dielectric constant, Hansen solubility parameter (δTotal), or boiling point in the disclosed ranges. In some embodiments, each solvent of the one or more solvents used in the disclosed method exhibits more than one dielectric constant, Hansen solubility parameter (δTotal), and boiling point in the disclosed ranges. In some embodiments, each solvent of the one or more solvents used in the disclosed method exhibits a dielectric constant, Hansen solubility parameter (δTotal), and boiling point in the disclosed ranges.

In some embodiments, the one or more solvent is selected from the group consisting of N,N′-dimethylacetamide, N,N′-dimethylformamide, sulfolane, propylene carbonate, ethylene carbonate, diethyl carbonate, dimethyl carbonate, dimethyl sulfoxide, diphenylether, glycerol, triethylphosphate, N-methyl-2-pyrrolidone, ethylacetoacetate, benzaldehyde, benzylalcohol, and a combination thereof. In some embodiments, the one or more solvent is selected from the group consisting of N,N′-dimethylacetamide, N,N′-dimethylformamide, sulfolane, propylene carbonate, ethylene carbonate, diethyl carbonate, dimethyl carbonate, dimethyl sulfoxide, and a combination thereof. In some embodiments, the solvent is propylene carbonate. In some embodiments, the solvent is dimethylformamide.

Solvents with solubility parameters outside the disclosed ranges, in accordance with this disclosure include, for example, mineral spirits, pentane, pentene, hexane, heptane, octane and the like, methyl cyclohexane, and diethyl ether. While solvents such as ethyl benzene, xylene, toluene, benzene, carbon tetrachloride, chloroform, trichloroethylene, tetrachloroethylene, and like halogenated hydrocarbons have solubility parameters within the defined ranges, such solvents have lower dielectric constant or low boiling point and are not satisfactory solvents in accordance with the method of this disclosure. Further, although nitrobenzene is encompassed by one or more disclosed range for the one or more solvent, this disclosure expressly excludes nitrobenzene.

In some embodiments, the sulfonated polyphenylene polymer is at least 50%, at least 70%, at least 80%, at least 90%, at least 95%, or at least 98% soluble in the one or more solvent. In some embodiments, the sulfonated polyphenylene copolymer is at least 50%, at least 70%, at least 80%, at least 90%, at least 95%, or at least 98% soluble in the one or more solvent. In some embodiments, the branched sulfonated polyphenylene polymer is at least 50%, at least 70%, at least 80%, at least 90%, at least 95%, or at least 98% soluble in the one or more solvent. In some embodiments, the branched sulfonated polyphenylene copolymer is at least 50%, at least 70%, at least 80%, at least 90%, at least 95%, or at least 98% soluble in the one or more solvent. In some embodiments, the hyperbranched sulfonated polyphenylene polymer is at least 50%, at least 70%, at least 80%, at least 90%, at least 95%, or at least 98% soluble in the one or more solvent. In some embodiments, the hyperbranched sulfonated polyphenylene copolymer is at least 50%, at least 70%, at least 80%, at least 90%, at least 95%, or at least 98% soluble in the one or more solvent.

In some embodiments, the polymerizing further comprises one or more steps of:
(i) adding the one or more solvents to a reaction vessel, followed by adding the cyclopentadienone of Formula (I), the cyclopentadienone of Formula (IV), the diethynyl arene of Formula (II), the triethynyl arene of Formula (VIII), or a combination thereof, at a temperature of about 20-25° C., to the reaction vessel;
(ii) mixing the cyclopentadienone of Formula (I), the cyclopentadienone of Formula (IV), the diethynyl arene of Formula (II), the triethynyl arene of Formula (VIII), or a combination thereof, in the reaction vessel by stirring or mechanical mixing to form a reaction mixture;
(iii) purging the reaction mixture with an inert gas (e.g., N₂ or Ar);
(iv) heating the reaction mixture to a temperature of about 130° C. to about 170° C. while mixing and maintaining a blanket of the inert gas over the reaction mixture or in the reaction vessel;
(v) maintaining the temperature of about 130° C. to about 170° C. for about 4 hours to about 100 hours;
(vi) cooling the mixture and adding a polar solvent;
(vii) adding 2M NaOH to produce a precipitate;
(viii) filtering and drying the precipitate to produce a dry polymer;
(ix) adding 2M HCl to the dry polymer and mixing to form a slurry;
(x) filtering and washing the slurry with deionized water until the deionized water elutes at a neutral pH to form a polymer, and
(xi) drying the polymer at about 70° C. to about 90° C.

In some embodiments, the sulfonated polyphenylene polymer, sulfonated polyphenylene copolymer, branched sulfonated polyphenylene polymer, branched sulfonated polyphenylene copolymer, hyperbranched sulfonated polyphenylene polymer, or hyperbranched sulfonated polyphenylene copolymer is used to form an ionomeric membrane.

In some embodiments, the sulfonated polyphenylene polymer, sulfonated polyphenylene copolymer, branched sulfonated polyphenylene polymer, branched sulfonated polyphenylene copolymer, hyperbranched sulfonated polyphenylene polymer, or hypethranched sulfonated polyphenylene copolymer, or the ionomeric membrane, is incorporated into a catalyst layer of a fuel cell, of an electrolyzer, or of another electrochemical device.

In some embodiments, disclosed herein is electrochemical device comprising the sulfonated polyphenylene polymer, sulfonated polyphenylene copolymer, branched sulfonated polyphenylene polymer, branched sulfonated polyphenylene copolymer, hyperbranched sulfonated polyphenylene polymer, and hyperbranched sulfonated polyphenylene copolymer as disclosed herein, or an ionomeric membrane, wherein the electrochemical device is a fuel cell, an electrolyzer, a redox flow battery, or another electrochemical device.

### EXAMPLES

### Example 1

### Synthesis of 4,4′-diethynylbiphenyl (DETB)

### Synthesis of 4,4′-bis((trimethylsilyl)ethynyl)biphenyl (BTEB) (Route A)

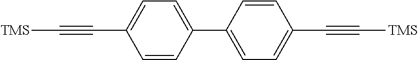 [SMILES: C[Si](C)(C)C#Cc1ccc(-c2ccc(C#C[Si](C)(C)C)cc2)cc1]

A mixture of 4,4′-diiodobiphenyl (10.09 g, 24.85 mmol) in diethylamine (320 mL) was prepared in a 500 mL 3-necked round-bottom flask with a stir bar, filled with argon. Catalytic amounts of Pd(PPh₃)₂Cl₂ (174.4 mg, 0.249 mmol) and CuI (47.3 mg, 0.249 mmol) were added, the flask was sealed with a septum and stirring initiated. Ethynyltrimethylsilane (7.43 mL, 52.19 mmol) was injected through the septum, and the resulting mixture was left to stir at 51° C. for 36 h. The reaction was cooled to room temperature, and the resulting white precipitate was removed by filtration and discarded. The filtrate was collected and the solvent mixture was removed under reduced pressure. The resulting dark brown residue was purified using column chromatography (hexanes on silica) to afford the pure product as a white crystalline solid (6.06 g, 17.48 mmol, 70.4%).

¹H NMR (500 MHz, Acetone-d₆) δ (ppm): 7.71 (d, J=7.9 Hz, 4H), 7.56 (d, J=7.8 Hz, 4H), 0.25 (s, 18H).

### Synthesis of 4,4′-diethynylbiphenyl (DETB) (Route A)

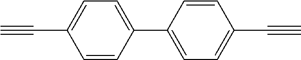 [SMILES: C#Cc1ccc(-c2ccc(C#C)cc2)cc1]

4,4′-bis((trimethylsilyl)ethynyl)biphenyl (1.80 g, 5.19 mmol) was dissolved in an ethyl ether/methanol solvent mixture (1:1, 30 mL) in a 50 mL round-bottom flask equipped with a stir bar. K₂CO₃ (7.18 g, 51.93 mmol) was added slowly under vigorous stirring, and the reaction was further stirred for 6 h at room temperature. The reaction was poured into water (250 mL), and the aqueous layer extracted with dichloromethane (3×125 mL). The organic extracts were combined, dried over MgSO4, and the solvent mixture was removed under reduced pressure to afford the pure product as a light beige crystalline solid (1.04 g, 5.14 mmol, 99.0%).

¹H NMR (500 MHz, Acetone-d₆) δ (ppm): 7.72 (d, J=8.2 Hz, 4H), 7.60 (d, J=8.2 Hz, 4H), 3.74 (s, 2H). Purity must be >99% (HPLC in methanol) to obtain high molecular weight polymer.

### Example 2

### Synthesis of 1,4-bis(2,4,5-triphenylcyclopentadienone) benzene (BTCB)

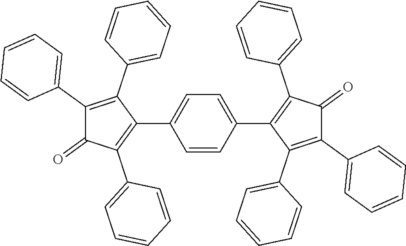 [SMILES: O=C1C(c2ccccc2)=C(c2ccccc2)C(c2ccc(C3=C(c4ccccc4)C(=O)C(c4ccccc4)=C3c3ccccc3)cc2)=C1c1ccccc1]

A mixture of anhydrous ethanol (600 mL), 1,4-bisbenzil (6.51 g, 19.02 mmol), and 1,3-(diphenyl)propan-2-one (8.40 g, 39.94 mmol) were combined in a 1 L two-neck round-bottom flask containing a stir bar. The flask was equipped with a condenser and capped addition funnel, and stirred at reflux for 1 h to allow for complete dissolution. KOH (2.14 g, 38.04 mmol dissolved in 10 mL anhydrous ethanol) solution was then added drop-wise to the yellow solution using the addition funnel. The resulting black solution was stirred at reflux for an additional 1 h, then cooled to 0° C. in an ice bath. The solution was filtered and the precipitate washed several times with ice-cold ethanol, and dried under vacuum at 80° C. for 8 h. The resulting black powder was dissolved in DCM and purified with column chromatography to yield BTCB as a dark purple, needle-like crystalline solid product (9.16 g, 13.26 mmol, 69.7%).

¹H NMR (500 MHz, CD₂Cl₂) δ (ppm): 7.30-7.18 (m, 26H), 6.92 (d, J=7.1 Hz, 4H), 6.78 (s, 4H).

Purity of BTCB should be >99% (by HPLC in dichloromethane or chloroform).

### Example 3

### Synthesis of tetra(para-sulfonated) bistetracyclone tetrakis (triethylammonium) salt (TPSB-TES)

### Tetra(para-sulfonated)bistetracyclone (TPSB)

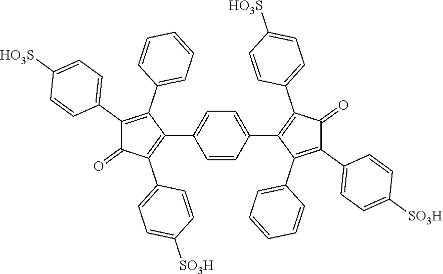 [SMILES: O=C1C(c2ccc(S(=O)(=O)O)cc2)=C(c2ccccc2)C(c2ccc(C3=C(c4ccc(S(=O)(=O)O)cc4)C(=O)C(c4ccc(S(=O)(=O)O)cc4)=C3c3ccccc3)cc2)=C1c1ccc(S(=O)(=O)O)cc1]

To a 1 L two-necked round-bottom flask with a stir bar was added dichloroethane (550 mL). It was equipped with a septum and a sealed drop funnel, and the system was degassed with argon. BTCB (6.00 g, 8.69 mmol) was added to the dichloroethane, and the mixture was stirred while degassing for 15 min. Trimethylsilyl chlorosulfonate (CAS 4353-77-9) (21.40 mL, 138.96 mmol) was diluted in 30 mL degassed dichloroethane, injected into the drop funnel, and added dropwise to the flask. The mixture was stirred for 16 h, then ethanol (3 mL) was added, followed by stirring for an additional 2 h. The reaction was poured into pentane (2 L), and the resulting precipitate was filtered, washed with pentane and cold ethyl ether. Drying under vacuum at 60° C. for 12 h afforded the product, TPSB, as a purple solid powder (8.43 g, 8.34 mmol, 96.0%).

¹H NMR (500 MHz, DMSO-D₆) δ (ppm): 7.53 (s, 4H, H₂O/H₃O⁺), 7.50 (d, J=8.2 Hz, 4H), 7.48 (d, J=8.2 Hz, 4H), 7.33 (m, 2H), 7.25 (t, J=7.5 Hz, 4H), 7.13 (d, J=8.3 Hz, 4H), 7.08 (d, J=8.3 Hz, 4H), 6.92 (d, J=7.4 Hz, 4H), 6.86 (s, 4H).

### Tetra(para-sulfonated) bistetracyclone tetrakis (triethylammonium) salt (TPSB-TES)

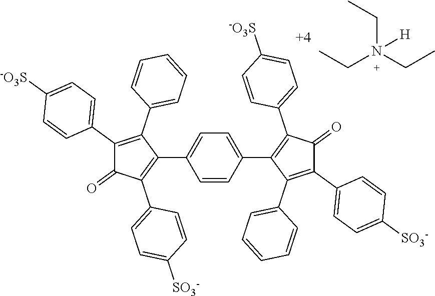

To a 1 L round-bottom flask containing butyl alcohol (300 mL) and a stir bar was added TPSB (6.50 g, 6.43 mmol). A dropping funnel was attached to the flask and triethylamine (144 mL, 1.03 mol) was added dropwise to the mixture, stirring vigorously. The reaction was stirred for 12 h, filtered, and the precipitate washed with hexanes (500 mL). Drying under vacuum at 120° C. for 72 h yielded the final product as a bright purple powder (9.02 g, 6.37 mmol, 99.1%).

¹H NMR (500 MHz, DMSO-D₆) δ (ppm): 8.85 (s, 4H), 7.49 (d, J=8.0 Hz, 4H), 7.47 (d, J=8.1 Hz, 4H), 7.33 (m, 2H), 7.25 (t, J=7.2 Hz, 4H), 7.13 (d, J=8.2 Hz, 4H), 7.09 (d, J=8.2 Hz, 4H), 6.92 (d, J=7.4 Hz, 4H), 6.86 (s, 4H), 3.09 (q, J=7.5 Hz, 24H), 1.17 (t, J=7.3 Hz, 36H).

Purity must be >99% (HPLC in methanol) to obtain high molecular weight polymer.

### Example 4

### Synthesis of Sulfonated Polyphenylene Polymer in Nitrobenzene

To a 5 L reactor flask containing argon, a mechanical stirrer, a thermocouple, and thermometer, were added TPSB-TES (100 g, 70.62 mmol), BTCB (5.4215 g, 7.847 mmol) and DETB (16.1109 g, 79.65 mmol), and nitrogen-purged (or argon-purged) nitrobenzene (1200 mL). After stirring for one hour at room temperature, the mixture was then heated to 150° C. and maintained at these temperatures (±2° C.) with medium stirring for 48-72 h. At this point, the reaction solution changed from a dark reddish-purple to a reddish-orange to light yellow color and the reaction mixture turned into a solid agglomerate gel. While the temperature of the solution was still >100° C., the nitrobenzene was removed by decantation and filtered to remove any insoluble material. Then, both the insoluble material and the remaining nitrobenzene-insoluble gel-contents of the flask were washed with acetone three times (1000 mL per wash). The insoluble material on the filtrate was then returned to the flask. Once the flask had cooled to room temperature, its contents were dissolved in methanol (6000-8000 mL). A 2 M NaOH solution in methanol (134.2 g NaOH in 1677 mL of Methanol) was added slowly to the polymer solution with rapid stirring. A precipitate formed immediately and stirring was continued overnight at room temperature. The suspension was then filtered and dried in the oven at 80° C. overnight. The dried polymer precipitate was then weighed (record the dry weight) and ground into a fine powder and stirred in 2 M HCl (6000 mL, 3×), at room temperature, for 4-24 hours. The solution was filtered, and the collected polymer precipitate was washed three times with water (40 L DI water/time at least), ensuring the polymer was neutralized. The pH value of the water coming out of the funnel was 7. The neutral polymer was then dried overnight at 86° C. to yield a dark brown chunky solid (77.5 g, 87.7%).

As described above, polymerization in nitrobenzene resulted in formation of polymer gels, making overall process difficult to control. Furthermore, due to polymer gelation during the course of polymerization, it is difficult to control the molecular weight of the target polymer. In contrast, the following examples illustrate advantages of polymer synthesis in alternative solvents.

### Example 5

### Synthesis of sulfonated polyphenylene polymer in propylene carbonate solvent

### (Propylene Carbonate Hansen Solubility Parameter (HSP) δTotal: 27.2; Dielectric Constant ε: 64)

To a 250 mL reactor flask containing argon, a mechanical stirrer, a thermocouple, and thermometer, were added TPSB-TES (19.2 g, 13.43 mmol) (500 g, 0.3496 mol), BTCB (1.031 g, 1.492 mmol) (26.838 g, 39 mmol) and DETB (3.138 g, 15.36 mmol) (80.542 g, 0.394 mol), and nitrogen-purged (or argon-purged) Propylene Carbonate (70 mL) (1822 mL). After stirring for one hour at room temperature, the mixture was then heated to 170° C. (NOTE: reaction mixture temperature itself should be monitored) and maintained at this temperature (±2° C.) with low to medium mechanical stirring (80-110 rpm) for approximately 60-72 h. During the course of polymerization, the color of the reaction mixture changed to a deep dark orange/brown color, and the solution became viscous. It is important to note that no gel formation was observed during the entire course of polymerization.

The reaction mixture was cooled down to 50-60° C. and methanol (2-3× initial reaction solvent volume) was added to allow dilution of the reaction mixture. The polymer was then recovered by precipitation by pouring the reaction mixture into a solution of NaOH 2M (50/50 water/methanol v/v) in about 6 times the initial reaction volume (ex: 400 mL for 70 mL of solvent reaction volume). The polymer was then recovered by either filtration or centrifugation and dried in the oven at 80° C. overnight. The solid polymer (dark orange/brown) was then slurried in a solution of 2M HCl 3 times for 4 hours with rapid mixing. The polymer was filtered or centrifuged and washed with deionized water until the pH of the filtrate was neutral. The polymer was dried at 80° C. in an oven overnight and characterized by ¹H NMR spectroscopy.

¹H NMR (500 MHz, DMSO-D6) δ (ppm): 6.02-7.60 (m, 40H), 4.19 (s, H₂O/H₃O⁺).

### Example 6

### Molecular Weight of Polymer by Gel Permeation Chromatography

The molecular weight (MW) of the polymers were determined by a Gel Permeation Chromatography (GPC) System with the system composed of Waters 1515 Isocratic HPLC pump, Waters 2414 Refractive Index, and Waters 2487 Dual wavelength Absorbance Detectors, and Waters HPLC HR 5, HR 4 and HR 3 columns using HPLC grade DMF (containing 0.05 M LiBr) as eluent. Purchased polystyrene samples were used as standards for the calibration. Samples were prepared: 5 to 10 mg were weighted in a vial, 1 mL of mobile phase was added to the sample, and the mixture stirred until complete dissolution. Then the sample was filtered through a 22 μm PTFE filter into the analytical GPC flask and injected into the system. The results were then obtained by integration of the peak area and correlated to polystyrene samples previously analyzed and used for calibration of the apparatus.

### Example 7

### Polymer Solution Viscosity Determination

Samples were prepared as 1% weight solution in DMSO and filtered before measurement.

The viscosity of polymer solutions was measured using falling ball viscometry. All polymer solutions were filtered through a 0.45 micrometer filter disk before viscosity measurement. A Glass Ball (GF-1332) was placed in the viscometer tube and the polymer solution was added until the tube was almost full. The tube was inverted upside down and the ball was allowed to slowly move and drop into its locknut. The tube was inverted again, and the ball released using the locknut. Care was taken to ensure that no bubbles were around or below the ball. The ball slowly moved down through the polymer solution. A stopwatch was used to measure the time it took for the ball to travel between the two sets of fiduciary lines.

Viscosity was calculated using the following equation:

$$Viscosity ( μ ) = K ( {d}_{ball} - {d}_{solvent} ) \times t / 60$$

where,
μ=viscosity in centipoises (cP)
d_{ball}=density of ball (g/mL) (2.53 for glass, 8.02 for stainless steel, and 16.6 for tantalum)
dₛₒₗᵥₑₙₜ=density of liquid (g/mL)
t=time of descent (seconds)
K=viscometer constant (measured using a known solvent)

Molecular weight (MW) of the polymer was assessed by measuring 1 wt % polymer solution in DMSO. A relative increase in viscosity of a polymer solution was taken as an indicator of increase in the relative molecular weight of the polymer.

### Example 8

### Effect of Monomer Concentration on the Polymer Molecular Weight

Molecular weight of sulphonated polyphenylene could be controlled by varying weight (or concentration) of monomers in propylene carbonate. Polymerizations in propylene carbonate were performed as described in Example 2. Table I shows molecular weight of the polymer increased as concentration of monomers increase for the solvent propylene carbonate (V).

TABLE I
Effect of monomer concentration on molecular weight of polymer
(propylene carbonate)

| | | | | Viscosity of 1 wt % |
|---|---|---|---|---|
| | | Polymerization | | Polymer Solution |
| | Monomers molar ratios | Temperature | Time | in DMSO |
| Solvent V/TPSB-TES | (TPSB-TES:BTCB:DETB) | ° C. | (h) | (cP) |
| 10 mL/1 g (10 wt %) | 0.9:0.1:1.015 | 155 | 48 | 11 |
| 8 mL/1 g (12.5 wt %) | 0.9:0.1:1.015 | 155 | 48 | 16 |
| 6 mL/1 g (16.6 wt %) | 0.9:0.1:1.015 | 155 | 48 | 24 |
| 70 mL/19.2 g (27.4 wt %) | 0.9:0.1:1.015 | 155 | 48 | 40 |

Data in Table I shows that polymerization in propylene carbonate solvent at varying concentrations of monomer affords control over the molecular weight of sulfonated polyphenylene polymer. Accordingly, with increasing monomer concentration in propylene carbonate, the polymer molecular weight increased, as reflected by increased solution viscosity of 1 wt % polymer solution in DMSO.

### Example 9

### Effect of Polymerization Time on Polymer Molecular Weight

Molecular weight of sulphonated polyphenylene could be controlled by varying reaction time in propylene carbonate. Polymerizations in propylene carbonate were performed as described in Example 5. Table II shows molecular weight of the polymer increased as polymerization time increased.

TABLE II
Effect of reaction time on polyphenylene molecular weight

| | Viscosity of 1 wt % Polymer |
|---|---|
| Polymerization Time | Solution in DMSO |
| (h) | (cP) |
| 8 | 8.2 |
| 24 | 11 |
| 36 | 16 |
| 48 | 18 |
| 72 | 24 |

Data in Table II shows that, at constant concentrations of monomers, increased polymerization time the propylene carbonate solvent resulted in increased sulfonated polyphenylene polymer molecular weight.

### Example 10

### Synthesis of sulfonated polyphenylene polymer in N,N′-dimethylacetamide

### HSP δTotal: 22.4|Dielectric Constant ε: 37.8

To a 250 mL reactor flask containing argon, a mechanical stirrer, a thermocouple, and thermometer, were added TPSB-TES (19.2 g, 13.43 mmol) (500 g, 0.3496 mol), BTCB (1.031 g, 1.492 mmol) (26.838 g, 39 mmol) and DETB (3.138 g, 15.36 mmol) (80.542 g, 0.394 mol), and nitrogen-purged (or argon-purged) N,N′-Dimethylacetamide (DMAC) (70 mL) (1822 mL) was added. After stirring for one hour at room temperature, the mixture was then heated to 170° C. (NOTE: the temperature of the reaction mixture itself should be monitored) and maintained at this temperature (±2° C.) with low to medium mechanical stirring (80-110 rpm) for ˜60-72 h. During polymerization, the color of the reaction mixture changed to deep dark orange/brown color, and the solution became viscous. It is important to note that no gel formation was observed during the entire course of polymerization.

The reaction mixture had cooled down to 50-60° C., and methanol (2-3× initial reaction solvent volume) was added to allow dilution of the reaction mixture. The polymer was then recovered by precipitation by pouring the reaction mixture into a solution of NaOH 2M (50/50 water/methanol v/v) in about 6 times the initial reaction volume (ex: 400 mL for 70 mL of solvent reaction volume). The polymer was then recovered by either filtration or centrifugation and dried in the oven at 80° C. overnight. The polymer bits (dark orange/brown) were then slurried in a solution of 2M HCl 3 times for 4 hours under rapid mixing. The polymer was then filtered or centrifuged and washed with deionized water until the pH of the filtrate was neutral. The polymer was then isolated and dried at 80° C. overnight to obtain the polymer with 85% to 90% yield and characterized with methods described below.

### Example 11

### Polymer Synthesis in Mixed Solvents

The Diels-Alder polymerization of monomers was performed as described in Example 5, but in a mixture of solvents A and B (1:1 v/v). HSP of the mixed solvents were obtained by using HSPiP software. All solvents used had boiling points above 100° C.

Table III shows the solvent A and B compositions, the HSP, and the viscosity.

TABLE III
Synthesis of Sulfonated Polyphenylene Polymer in Solvent Mixtures

| | | HSP of mixed | | | | |
|---|---|---|---|---|---|---|
| | | solvent | | | | |
| | | (dielectric | | | | Polymer |
| | | constant) | | | | Yield |
| Solvent A | Solvent B | δD | δP | δH | δTotal | (Viscosity) |
| Propylene carbonate | Phenoxyethanol | 18.9 | 11.9 | 9.2 | 24.5 | 85% |
| Propylene carbonate | Glycerol | 18.7 | 14.7 | 15.7 | 28.5 | 80% |
| N,N′-Dimethylacetamide | Propylene carbonate | 18.4 | 14.8 | 6.8 | 24.6 | 80% |
| Sulfolane | Propylene carbonate | 18.9 | 17.7 | 6.4 | 26.7 | 70% |
| Phenoxyethanol | Glycerol | 17.6 | 8.5 | 20.8 | 28.5 | 50% |

### EMBODIMENTS

Embodiment 1. A method of making a sulfonated polyphenylene polymer, comprising:
polymerizing a sulfonated bis-cyclopentadienone of Formula (I) with a diethynyl arene of Formula (II) in one or more solvents,
wherein Formula (I) has the structure:

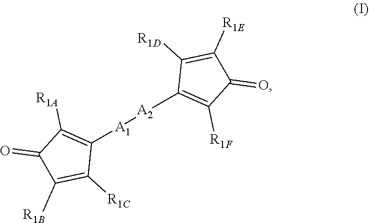

wherein Formula (II) has the structure:

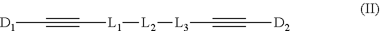

and
wherein:
R_{1A}, R_{1B}, R_{1C}, R_{1D}, R_{1E}, and R_{1F} are independently aryl or heteroaryl, each unsubstituted or substituted with 1, 2, 3, 4, or 5 substituents independently selected from C₁ alkyl, halo, SO₃⁻X⁺, PO₃²⁻2X⁺, and COO⁻X⁺, and provided that at least two of R_{1A}, R_{1B}, R_{1C}, R_{1D}, R_{1E}, and R_{1F} are independently aryl or heteroaryl substituted with 1, 2, 3, 4, or 5 substituents independently selected from SO₃⁻X⁺, PO₃²⁻2X⁺, and COO⁻X⁺;
A₁ is arylene, heteroarylene, aralkylene, or heteroaralkylene, wherein said arylene, heteroarylene, aralkylene, and heteroaralkylene are unsubstituted or substituted with 1, 2, 3, or 4 substituents independently selected from halo, nitro, cyano, aryl, and heteroaryl;
A₂ is absent, arylene, or heteroarylene, wherein said arylene and heteroarylene are unsubstituted or substituted with 1, 2, 3, or 4 substituents independently selected from halo, nitro, cyano, aryl, and heteroaryl;
L₁ is an unsubstituted or substituted linking heteroatom, arylene, heteroarylene, aralkylene, or heteroaralkylene, wherein the arylene, heteroarylene, aralkylene, and heteroaralkylene are unsubstituted or substituted with 1, 2, 3, or 4 substituents independently selected from C₁₋₆ alkyl, halo, nitro, cyano, aryl, and heteroaryl;
L₂ and L₃ are each independently absent, arylene, or heteroarylene, wherein said arylene and heteroarylene are unsubstituted or substituted with 1, 2, 3, or 4 substituents independently selected from C₁₋₆ alkyl, halo, nitro, cyano, aryl, and heteroaryl;
D₁ and D₂ are each independently H, R_{1G}, or R_{1H};
R_{1G} and R_{1H} are each independently H, aryl, or heteroaryl, wherein the aryl and heteroaryl are unsubstituted or substituted with 1, 2, 3, 4, or 5 substituents independently selected from C₁₋₆ alkyl, halo, nitro, cyano, SO₃⁻X⁺, PO₃²⁻2X⁺, and COO⁻X⁺; and
X⁺ is H⁺ or a cation, and
wherein the one or more solvent is not nitrobenzene.

Embodiment 2. The method of Embodiment 1, wherein each of the one or more solvents has a dielectric constant of at least about 3.6, a Hansen solubility parameter (δTotal) of 50 or less, a boiling point at atmospheric pressure between about 100° C. and about 600° C., or a combination thereof.

Embodiment 3. The method of Embodiment 1 or 2, wherein the one or more solvent is selected from the group consisting of N,N′-dimethylacetamide, N,N′-dimethylformamide, sulfolane, propylene carbonate, ethylene carbonate, diethyl carbonate, dimethyl carbonate, dimethyl sulfoxide, diphenylether, glycerol, triethylphosphate, N-methyl-2-pyrrolidone, ethylacetoacetate, benzaldehyde, benzylalcohol, and a combination thereof.

Embodiment 4. The method of any one of Embodiments 1-3, wherein the one or more solvent is selected from the group consisting of N,N′-dimethylacetamide, N,N′-dimethylformamide, sulfolane, propylene carbonate, ethylene carbonate, diethyl carbonate, dimethyl carbonate, dimethyl sulfoxide, and a combination thereof.

Embodiment 5. The method of any one of Embodiments 1-4, wherein the one or more solvent has a dielectric constant of about 3.6 to about 80.

Embodiment 6. The method of any one of Embodiments 1-5, wherein the one or more solvent has a Hansen solubility parameter (δTotal) of about 18 to about 36.

Embodiment 7. The method of any one of Embodiments 1-6, wherein the one or more solvent has a boiling point at atmospheric pressure of between about 130° C. and about 250° C.

Embodiment 8. The method of any one of Embodiments 1-7, wherein the sulfonated polyphenylene polymer has a repeat unit (x) of Formula (III):

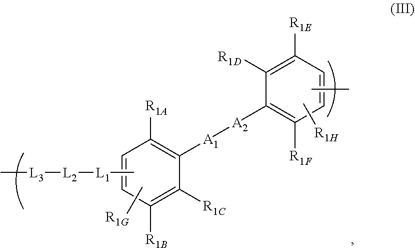

wherein:
R_{1A}, R_{1B}, R_{1C}, R_{1D}, R_{1E}, and R_{1F} are independently aryl or heteroaryl, each unsubstituted or substituted with 1, 2, 3, 4, or 5 substituents independently selected from C₁₋₆ alkyl, halo, nitro, cyano, SO₃⁻X⁺, PO₃²⁻2X⁺, and COO⁻X⁺, and provided that at least two of R_{1A}, R_{1B}, R_{1C}, R_{1D}, R_{1E}, and R_{1F} are independently aryl or heteroaryl substituted with 1, 2, 3, 4, or 5 substituents independently selected from SO₃⁻X⁺, PO₃²⁻2X⁺, and COO⁻X⁺;
R_{1G} and R_{1H} are each independently H, aryl, or heteroaryl, wherein said aryl and heteroaryl are unsubstituted or substituted with 1, 2, 3, 4, or 5 substituents independently selected from C₁₋₆ alkyl, halo, nitro, cyano, SO₃⁻X⁺, PO₃²⁻2X⁺, and COO⁻X⁺;
A₁ is arylene, heteroarylene, aralkylene, or heteroaralkylene, wherein said arylene, heteroarylene, aralkylene, and heteroaralkylene are unsubstituted or substituted with 1, 2, 3, or 4 substituents independently selected from halo, nitro, cyano, aryl, and heteroaryl;
A₂ is absent, arylene, or heteroarylene, wherein said arylene and heteroarylene are unsubstituted or substituted with 1, 2, 3, or 4 substituents independently selected from halo, nitro, cyano, aryl, and heteroaryl;
L₁ is an unsubstituted or substituted linking heteroatom, arylene, heteroarylene, aralkylene, or heteroaralkylene, wherein said arylene, heteroarylene, aralkylene, and heteroaralkylene are unsubstituted or substituted with 1, 2, 3, or 4 substituents independently selected from C₁₋₆ alkyl, halo, nitro, cyano, aryl, and heteroaryl;
L₂ and L₃ are each independently absent, arylene, or heteroarylene, wherein said arylene and heteroarylene are unsubstituted or substituted with 1, 2, 3, or 4 substituents independently selected from C₁-6 alkyl, halo, nitro, cyano, aryl, and heteroaryl; and
X⁺ is H⁺ or a cation.

Embodiment 9. The method of any one of Embodiments 1-8, further comprising polymerizing with a bis-cyclopentadienone of Formula (IV) to form a sulfonated polyphenylene copolymer, wherein Formula (IV) has the structure:

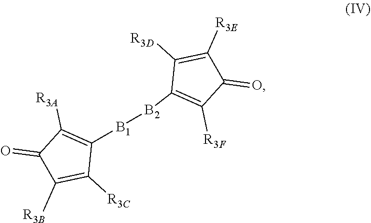

R_{3A}, R_{3B}, R_{3C}, R_{3D}, R_{3E}, and R_{3F} are independently aryl or heteroaryl, each unsubstituted or substituted with 1, 2, 3, 4, or 5 substituents independently selected from C₁₋₆ alkyl, halo, nitro, and cyano;
B₁ is arylene, heteroarylene, aralkylene, or heteroaralkylene, wherein said arylene, heteroarylene, aralkylene, and heteroaralkylene are unsubstituted or substituted with 1, 2, 3, or 4 substituents independently selected from halo, nitro, cyano, aryl, and heteroaryl; and
B₂ is absent, arylene, or heteroarylene, wherein said arylene and heteroarylene are unsubstituted or substituted with 1, 2, 3, or 4 substituents independently selected from halo, nitro, cyano, aryl, and heteroaryl.

Embodiment 10. The method of Embodiment 9, wherein the sulfonated polyphenylene copolymer comprises a hydrophobic polyphenylene repeat unit (y) of Formula (V), wherein Formula (V) has the structure:

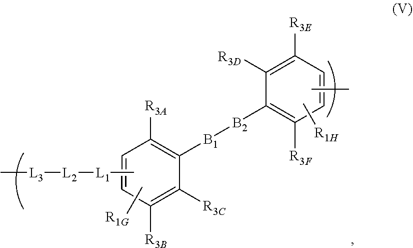

wherein:
R_{3A}, R_{3B}, R_{3C}, R_{3D}, R_{3E}, and R_{3F} are independently aryl or heteroaryl, each unsubstituted or substituted with 1, 2, 3, 4, or 5 substituents independently selected from C₁₋₆ alkyl, halo, nitro, and cyano;
R_{1G} and R_{1H} are independently H, aryl, or heteroaryl, wherein said aryl and heteroaryl are unsubstituted or substituted with 1, 2, 3, 4, or 5 substituents independently selected from C₁₋₆ alkyl, halo, nitro, and cyano;
B₁ is independently arylene, heteroarylene, aralkylene, or heteroaralkylene, wherein said arylene, heteroarylene, aralkylene, and heteroaralkylene are unsubstituted or substituted with 1, 2, 3, or 4 substituents independently selected from halo, nitro, cyano, aryl, and heteroaryl;
B₂ is independently absent, arylene, or heteroarylene, wherein said arylene and heteroarylene are unsubstituted or substituted with 1, 2, 3, or 4 substituents independently selected from halo, nitro, cyano, aryl, and heteroaryl;
L₁ is independently an unsubstituted or substituted linking heteroatom, arylene, heteroarylene, aralkylene, or heteroaralkylene, wherein said arylene, heteroarylene, aralkylene, and heteroaralkylene are each unsubstituted or substituted with 1, 2, 3, or 4 substituents independently selected from C₁₋₆ alkyl, halo, nitro, cyano, aryl, and heteroaryl; and
L₂ and L₃ are independently absent, arylene, or heteroarylene, wherein said arylene and heteroarylene are unsubstituted or substituted with 1, 2, 3, or 4 substituents independently selected from C₁₋₆ alkyl, halo, nitro, cyano, aryl, and heteroaryl.

Embodiment 11. The method of any one of Embodiments 9-10, wherein the sulfonated polyphenylene copolymer has a structure of Formula (VI):

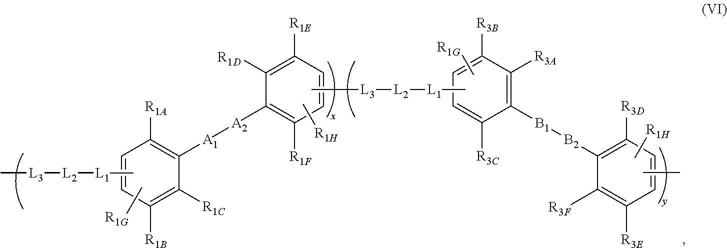

wherein:
R_{1A}, R_{1B}, R_{1C}, R_{1D}, R_{1E}, and R_{1F} are independently aryl or heteroaryl, each unsubstituted or substituted with 1, 2, 3, 4, or 5 substituents independently selected from C₁₋₆ alkyl, halo, nitro, cyano, SO₃⁻X⁺, PO₃²⁻2X⁺, and COO⁻X⁺;
R_{3A}, R_{3B}, R_{3C}, R_{3D}, R_{3E}, and R_{3F} are independently aryl or heteroaryl, each unsubstituted or substituted with 1, 2, 3, 4, or 5 substituents independently selected from C₁₋₆ alkyl, halo, nitro, and cyano;
R_{1G} and R_{1H} are each independently H, aryl, or heteroaryl, wherein said aryl and heteroaryl are unsubstituted or substituted with 1, 2, 3, 4, or 5 substituents independently selected from C₁₋₆ alkyl, halo, nitro, cyano, SO₃⁻X⁺, PO₃²⁻2X⁺, and COO⁻X⁺;
A₁ and B₁ are each independently arylene, heteroarylene, aralkylene, or heteroaralkylene, wherein said arylene, heteroarylene, aralkylene, and heteroaralkylene are unsubstituted or substituted with 1, 2, 3, or 4 substituents independently selected from C₁₋₆ alkyl, halo, nitro, cyano, aryl, and heteroaryl;
A₂ and B₂ are each independently absent, arylene, or heteroarylene, wherein said arylene and heteroarylene are unsubstituted or substituted with 1, 2, 3, or 4 substituents independently selected from C₁₋₆ alkyl, halo, nitro, cyano, aryl, and heteroaryl;
L₁ are each independently an unsubstituted or substituted linking heteroatom, arylene, heteroarylene, aralkylene, or heteroaralkylene, wherein said arylene, heteroarylene, aralkylene, and heteroaralkylene are unsubstituted or substituted with 1, 2, 3, or 4 substituents independently selected from C₁₋₆ alkyl, halo, nitro, cyano, aryl, and heteroaryl;
L₂ and L₃ are each independently absent, arylene, or heteroarylene, wherein said arylene and heteroarylene are unsubstituted or substituted with 1, 2, 3, or 4 substituents independently selected from C₁-6 alkyl, halo, nitro, cyano, aryl, and heteroaryl, and
X⁺ is H⁺ or a cation.

Embodiment 12. The method of any one of Embodiments 9-11, wherein the polyphenylene copolymer has a structure of Formula (VII):

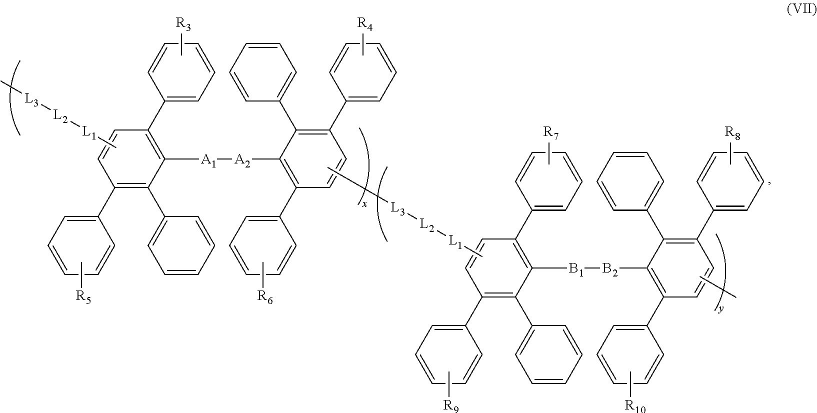

wherein:
R₃, R₄, R₅, and R₆ are each independently selected from H, SO₃⁻X⁺, PO₃²⁻2X⁺, and COO⁻X⁺;
R₇, R₈, R₉, and R₁₀ are each independently selected from H, C₁₋₆ alkyl, halo, nitro, and cyano;
A₁ and B₁ are each independently arylene, heteroarylene, aralkylene, or heteroaralkylene, wherein said arylene, heteroarylene, aralkylene, and heteroaralkylene are unsubstituted or substituted with 1, 2, 3, or 4 substituents independently selected from C₁₋₆ alkyl, halo, nitro, cyano, aryl, and heteroaryl;
A₂ and B₂ are each independently absent, arylene, heteroarylene, aralkylene, or heteroaralkylene, wherein said arylene, heteroarylene, aralkylene, and heteroaralkylene are unsubstituted or substituted with 1, 2, 3, or 4 substituents independently selected from C₁₋₆ alkyl, halo, nitro, cyano, aryl, and heteroaryl;
L₁ are each independently an unsubstituted or substituted linking heteroatom, arylene, heteroarylene, aralkylene, or heteroaralkylene, wherein said arylene, heteroarylene, aralkylene, and heteroaralkylene are unsubstituted or substituted with 1, 2, 3, or 4 substituents independently selected from C₁₋₆ alkyl, halo, nitro, cyano, aryl, and heteroaryl;
L₂ and L₃ are each independently absent, arylene, or heteroarylene, wherein said arylene and heteroarylene are unsubstituted or substituted with 1, 2, 3, or 4 substituents independently selected from C₁₋₆ alkyl, halo, nitro, cyano, aryl, and heteroaryl; and
X⁺ is H⁺ or a cation.

Embodiment 13. The method of any one of Embodiments 1-12, further comprising polymerizing with a triethynyl arene of Formula (VIII), to form a branched or hypethranched structure, wherein Formula (VIII) has the structure:

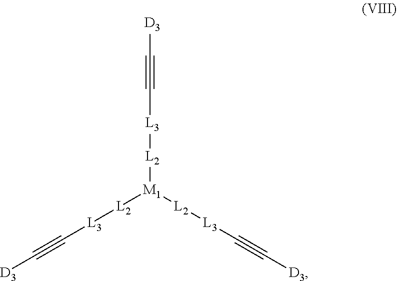

wherein
D₃ are each independently H, R_{1G}, or R_{1H}, and
M₁ is an unsubstituted or substituted linking atom, arylene, heteroarylene, aralkylene, or heteroaralkylene, wherein the arylene, heteroarylene, aralkylene, and heteroaralkylene are each unsubstituted or substituted with 1, 2, or 3 substituents independently selected from C₁₋₆ alkyl, halo, nitro, cyano, aryl, and heteroaryl.

Embodiment 14. The method of Embodiment 13, wherein the branched or structure has a structure of Formula (IX):

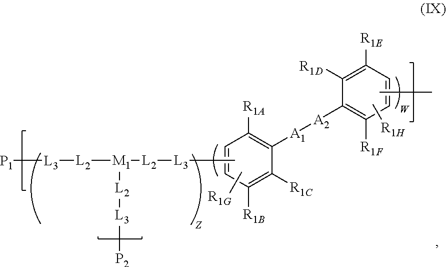

wherein P₁ and P₂ are independently selected from a repeat unit (x) of Formula (III) and a repeat unit (y) of Formula (V);
M₁ is an unsubstituted or substituted linking atom, arylene, heteroarylene, aralkylene, or heteroaralkylene, wherein the arylene, heteroarylene, aralkylene, and heteroaralkylene are unsubstituted or substituted with 1, 2, or 3 substituents independently selected from C₁₋₆ alkyl, halo, nitro, cyano, aryl, and heteroaryl;
L₂ and L₃ are each independently absent, arylene, or heteroarylene, wherein said arylene and heteroarylene are unsubstituted or substituted with 1, 2, 3, or 4 substituents independently selected from C₁₋₆ alkyl, halo, nitro, cyano, aryl, and heteroaryl;
A₁ is arylene, heteroarylene, aralkylene, or heteroaralkylene, wherein said arylene, heteroarylene, aralkylene, and heteroaralkylene are unsubstituted or substituted with 1, 2, 3, or 4 substituents independently selected from halo, nitro, cyano, aryl, and heteroaryl;
A₂ is absent, arylene, or heteroarylene, wherein said arylene and heteroarylene are unsubstituted or substituted with 1, 2, 3, or 4 substituents independently selected from halo, nitro, cyano, aryl, and heteroaryl;
R_{1A}, R_{1B}, R_{1C}, R_{1D}, R_{1E}, and R_{1F} are independently aryl or heteroaryl, each unsubstituted or substituted with 1, 2, 3, 4, or 5 substituents independently selected from C₁ alkyl, halo, SO₃⁻X⁺, PO₃²⁻2X⁺, and COO⁻X⁺, and provided that at least two of R_{1A}, R_{1B}, R_{1C}, R_{1D}, R_{1E}, and R_{1F} are independently aryl or heteroaryl substituted with 1, 2, 3, 4, or 5 substituents independently selected from SO₃⁻X⁺, PO₃²⁻2X⁺, and COO⁻X⁺;
R_{1G} and R_{1H} are independently H, aryl, or heteroaryl, wherein the aryl and heteroaryl are unsubstituted or substituted with 1, 2, 3, 4, or 5 substituents independently selected from C₁₋₆ alkyl, halo, nitro, cyano, SO₃⁻X⁺, PO₃²⁻2X⁺, and COO⁻X⁺; and
X⁺ is H⁺ or a cation, and
wherein a ratio of z:w is greater than 0.2.

Embodiment 15. The method of Embodiment 13 or 14, wherein M₁ is bound through a covalent bond to at least 3 repeat units, and wherein M₁ is selected from the group consisting of:

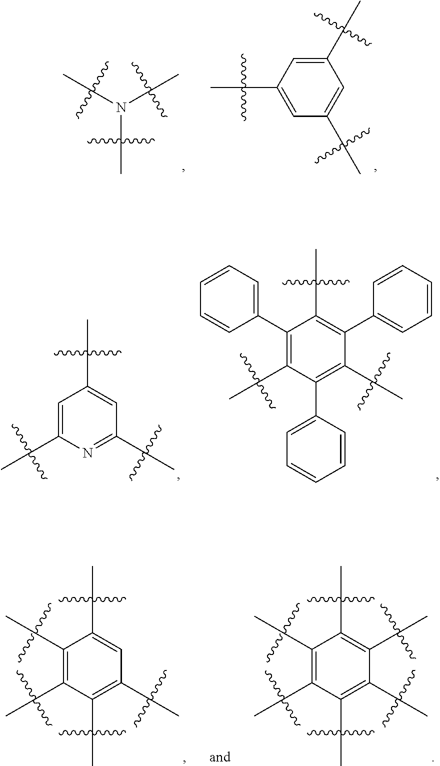

Embodiment 16. The method of any one of Embodiments 13-15, wherein the ratio of z:w is about 0.67.

Embodiment 17. The method of any one of Embodiments 1-16, wherein R_{1A}, R_{1B}, R_{1C}, R_{1D}, R_{1E}, and R_{1F} are each independently aryl, wherein the aryl is unsubstituted or substituted with 1, 2, 3, 4, or 5 substituents each independently selected from C₁₋₆ alkyl, halo, and SO₃⁻X⁺, wherein X⁺ is H⁺ or a cation, and provided that at least two of R_{1A}, R_{1B}, R_{1C}, R_{1D}, R_{1E}, and R_{1F} are independently aryl substituted with 1, 2, 3, 4, or 5 SO₃⁻X⁺.

Embodiment 18. The method of any one of Embodiments 9-17, wherein R_{3A}, R_{3B}, R_{3C}, R_{3D}, R_{3E}, and R_{3F} are each independently aryl, wherein the aryl is unsubstituted or substituted with 1, 2, 3, 4, or 5 substituents each independently selected from C₁₋₆ alkyl and halo.

Embodiment 19. The method of any one of Embodiments 1-18, wherein A₁ is arylene, wherein the arylene is unsubstituted or substituted with 1, 2, 3, or 4 substituents each independently selected from halo, nitro, cyano, aryl, and heteroaryl, and A₂ is absent.

Embodiment 20. The method of any one of Embodiments 9-19, wherein B₁ is arylene, wherein the arylene is unsubstituted or substituted with 1, 2, 3, or 4 substituents each independently selected from halo, nitro, cyano, aryl, and heteroaryl, and B₂ is absent.

Embodiment 21. The method of any one of Embodiments 1-20, wherein L₁ is naphthalenylene, phenylene, or C₁₋₆ alkyl-substituted phenylene, and L₂ and L₃ are each independently absent or phenylene, wherein when present, each phenylene is unsubstituted or substituted with 1, 2, 3, or 4 substituents each independently selected from C₁₋₆ alkyl and halo, and wherein L₁ of Formula (III) is the same or different from L₁ of Formula (V), L₂ of Formula (III) is the same or different from L₂ of Formula (V), and L₃ of Formula (III) is the same or different from L₃ of Formula (V).

Embodiment 22. The method of any one of Embodiments 1-21, wherein each L₃, L₂, and L₁ of -L₃-L₂-L₁-, and each L₃ and L₂, of -L 3-L₂-M₁-, when present, are independently selected from the group consisting of:

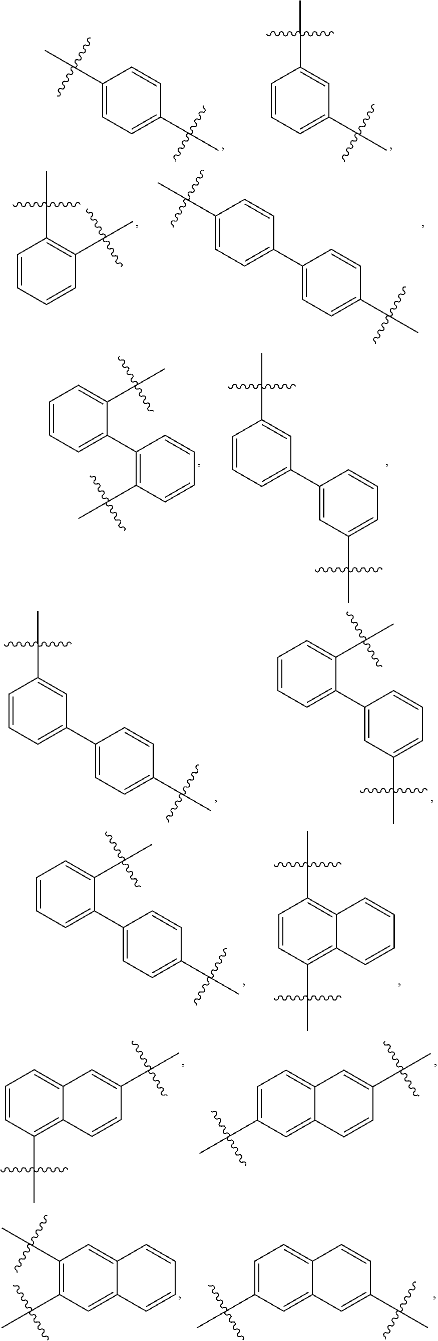

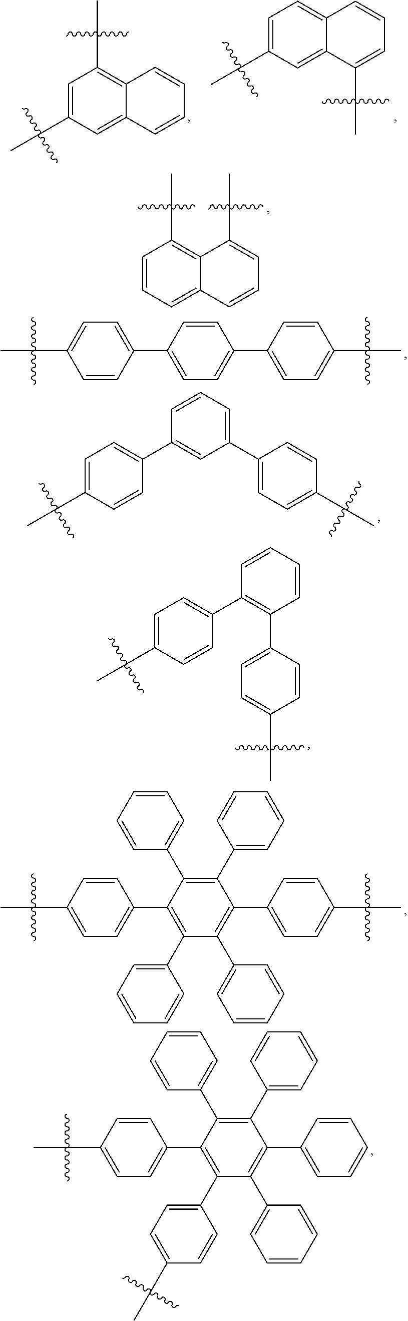

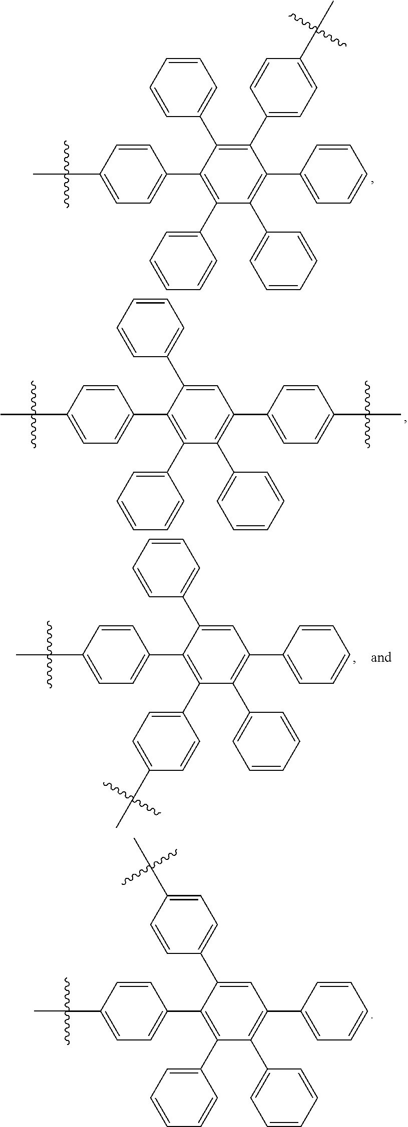

Embodiment 23. The method of any one of Embodiments 1-22, wherein the sulfonated polyphenylene polymer repeat unit (x) of Formula (III) is selected from:

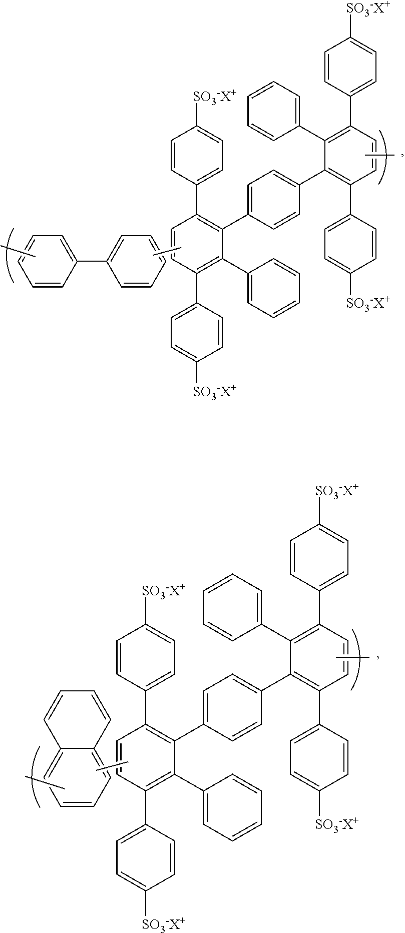

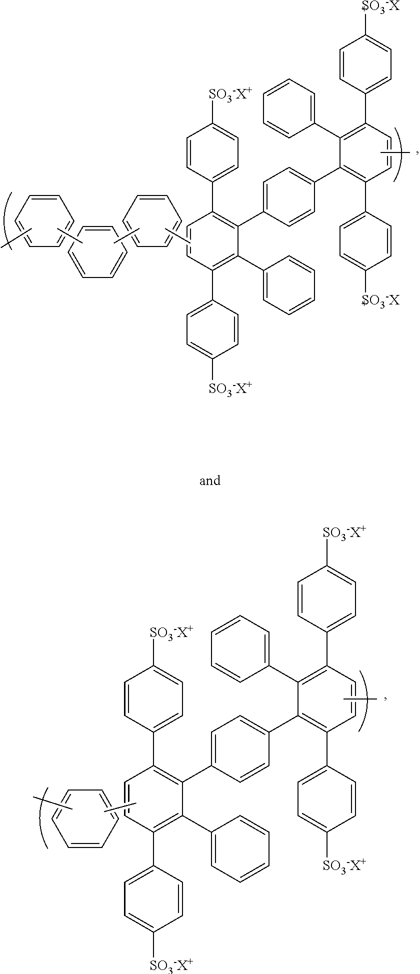

wherein X⁺ is H⁺, or a cation.

Embodiment 24. The method of any one of Embodiments 1-23, wherein the sulfonated polyphenylene polymer repeat unit (x) of Formula (III) is selected from:

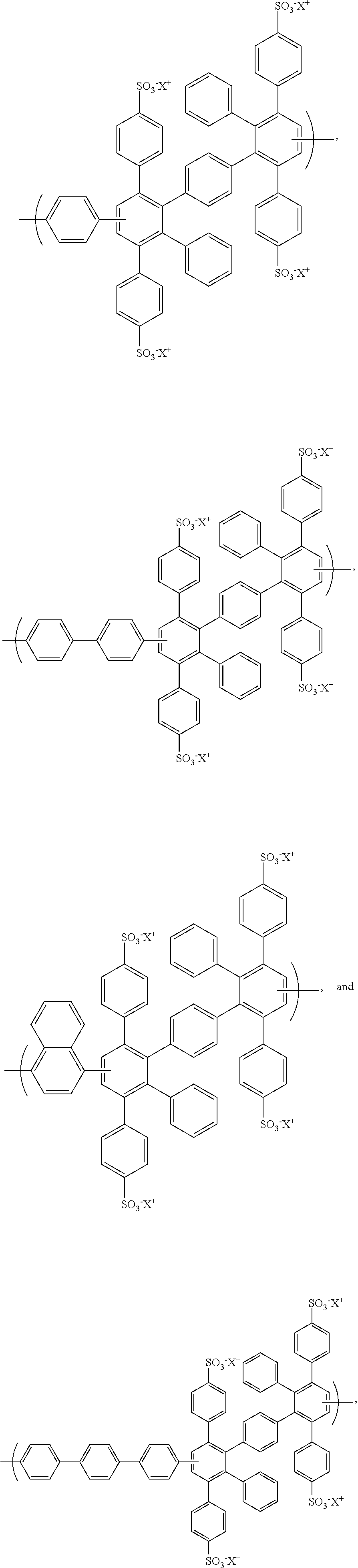

wherein X⁺ is H⁺ or a cation.

Embodiment 25. The method of any one of Embodiments 9-24, wherein the hydrophobic polyphenylene repeat unit (y) of Formula (V) is selected from:

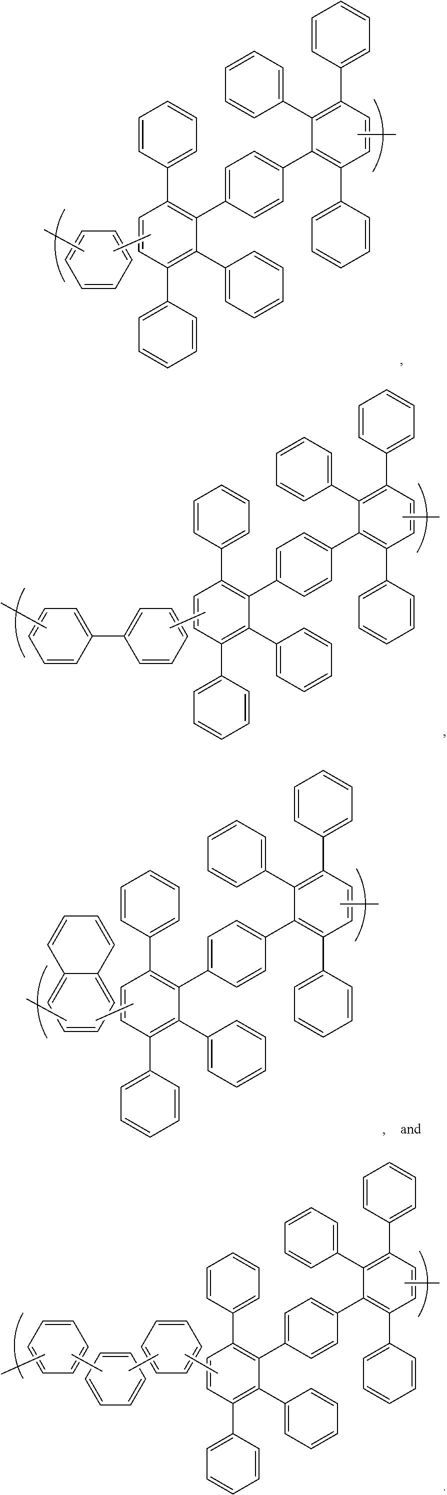

26. The method of any one of Claims 9-25, wherein the hydrophobic polyphenylene repeat unit (y) of Formula (V) is selected from:

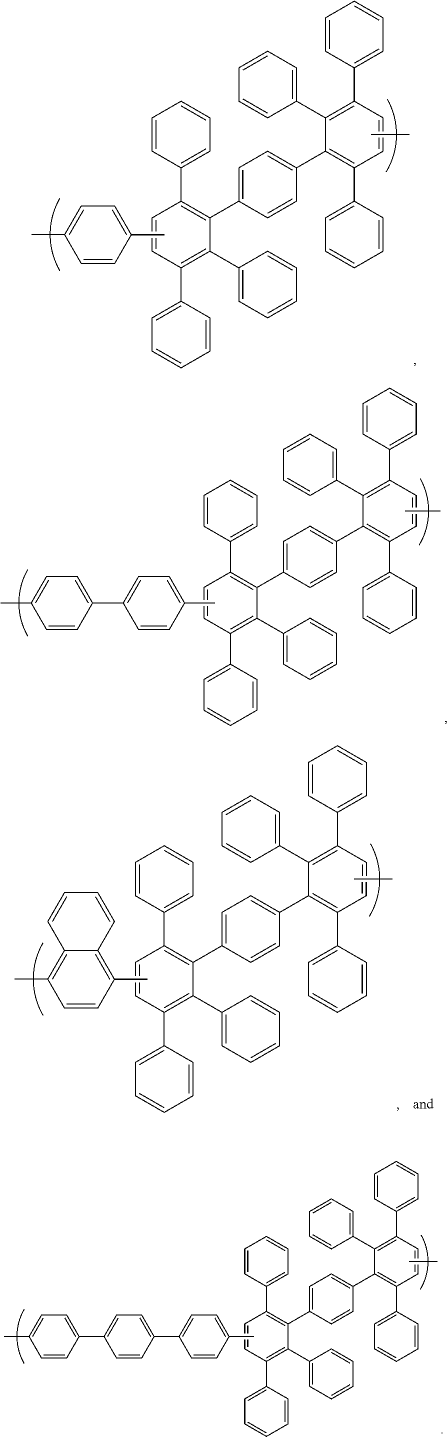

Embodiment 27. The method of any one of Embodiments 9-26, wherein the polymerizing comprises about a 59-99 mole % of the sulfonated bis-cyclopentadienone of Formula (I) and about 41-1 mole % of the bis-cyclopentadienone of Formula (IV).

Embodiment 28. The method of Embodiment 27, wherein the mole percent of (x) is about 59% to about 99%, and the mole percent of (y) is about 41% to about 1%.

Embodiment 29. The method of any one of Embodiments 9-28, wherein the polymerizing comprises about a 90:10 ratio of the sulfonated bis-cyclopentadienone of Formula (I) to the bis-cyclopentadienone of Formula (IV).

Embodiment 30. The method of Embodiment 29, wherein the mole percent of (x) is about 90%, and the mole percent of (y) is about 10%.

Embodiment 31. The method of any one of Embodiments 9-30, wherein the sulfonated polyphenylene copolymer is a random copolymer comprising a random distribution of Formula (III) and Formula (V), and wherein a mole ratio of the sulfonated polyphenylene polymer repeat unit (x) of Formula (III) to the hydrophobic polyphenylene repeat unit (y) of Formula (V) ranges from about 1:99 to about 99:1.

Embodiment 32. The method of any one of Embodiments 9-30, wherein the sulfonated polyphenylene copolymer is a statistical copolymer comprising an average composition ratio of the repeat unit (x) of Formula (III) and repeat unit (y) of Formula (V).

Embodiment 33. The method of any one of Embodiments 9-30, wherein the sulfonated polyphenylene copolymer is a random block copolymer wherein:
(x) is an integer from 3 to 100,
(y) is an integer from 3 to 100; and
wherein a mole ratio of a first block to a second block ranges from about 1:99 to about 99:1.

Embodiment 34. The method of any one of Embodiments 1-33, wherein X⁺ is H⁺; a cation; an alkali metal ion; [N(R_{A})(R_{B})(R_{C})(R_{D})]⁺ wherein R_{A}, R_{B}, R_{C}, and R_{D} are independently H, C₁₋₆ alkyl, aryl, or heteroaryl; or a combination thereof.

Embodiment 35. The method of any one of Embodiments 1-34, wherein the sulfonated polyphenylene polymer is soluble in the one or more solvent.

Embodiment 36. The method of any one of Embodiments 1-35, wherein the sulfonated polyphenylene polymer has a molecular weight of between about 100 kDa and about 5,000 kDa.

Embodiment 37. The method of any one of Embodiments 9-34, wherein the sulfonated polyphenylene copolymer is soluble in the one or more solvent.

Embodiment 38. The method of any one of Embodiments 9-34 or 37, wherein the sulfonated polyphenylene copolymer has a molecular weight of between about 100 kDa and about 5,000 kDa.

Embodiment 39. The method of any one of Embodiments 13-34, wherein the branched sulfonated polyphenylene polymer or hyperbranched sulfonated polyphenylene polymer is soluble in the one or more solvent.

Embodiment 40. The method of any one of Embodiments 13-34 or 39, wherein the branched sulfonated polyphenylene polymer or hyperbranched sulfonated polyphenylene polymer has a molecular weight of between about 100 kDa and about 5,000 kDa.

Embodiment 41. The method of any one of Embodiments 1-40, wherein the polymerizing further comprises one or more steps of:
(i) adding the one or more solvents to a reaction vessel, followed by adding the cyclopentadienone of Formula (I), the cyclopentadienone of Formula (IV), the diethynyl arene of Formula (II), the triethynyl arene of Formula (VIII), or a combination thereof, at a temperature of about 20-25° C., to the reaction vessel;
(ii) mixing the cyclopentadienone of Formula (I), the cyclopentadienone of Formula (IV), the diethynyl arene of Formula (II), the triethynyl arene of Formula (VIII), or a combination thereof, in the reaction vessel by stirring or mechanical mixing to form a reaction mixture;
(iii) purging the reaction mixture with an inert gas (e.g., N₂ or Ar);
(iv) heating the reaction mixture to a temperature of about 130° C. to about 170° C. while mixing and maintaining a blanket of the inert gas over the reaction mixture or in the reaction vessel;
(v) maintaining the temperature of about 130° C. to about 170° C. for about 4 hours to about 100 hours;
(vi) cooling the mixture and adding a polar solvent;
(vii) adding 2M NaOH to produce a precipitate;
(viii) filtering and drying the precipitate to produce a dry polymer;
(ix) adding 2M HCl to the dry polymer and mixing to form a slurry;
(x) filtering and washing the slurry with deionized water until the deionized water elutes at a neutral pH to form a polymer, and
(xi) drying the polymer at about 70° C. to about 90° C.

Embodiment 42. The method of any one of Embodiments 1-41, wherein the sulfonated polyphenylene polymer, sulfonated polyphenylene copolymer, branched sulfonated polyphenylene polymer, branched sulfonated polyphenylene copolymer, hyperbranched sulfonated polyphenylene polymer, or hyperbranched sulfonated polyphenylene copolymer is used to form an ionomeric membrane.

Embodiment 43. The method of any one of Embodiments 1-41, wherein the sulfonated polyphenylene polymer, sulfonated polyphenylene copolymer, branched sulfonated polyphenylene polymer, branched sulfonated polyphenylene copolymer, hyperbranched sulfonated polyphenylene polymer, hyperbranched sulfonated polyphenylene copolymer, or the ionomeric membrane of Embodiment 42, is incorporated into a catalyst layer of a fuel cell, of an electrolyzer, or of another electrochemical device.

Embodiment 44. An electrochemical device comprising the sulfonated polyphenylene polymer, sulfonated polyphenylene copolymer, branched sulfonated polyphenylene polymer, branched sulfonated polyphenylene copolymer, hyperbranched sulfonated polyphenylene polymer, or hyperbranched sulfonated polyphenylene copolymer of any one of Embodiments 1-41, or the ionomeric membrane of Embodiment 42, wherein the electrochemical device is a fuel cell, an electrolyzer, a redox flow battery, or another electrochemical device.

While illustrative embodiments have been illustrated and described, it will be appreciated that various changes can be made therein without departing from the spirit and scope of the invention.

1. A method of making a sulfonated polyphenylene polymer, comprising:
polymerizing a sulfonated bis-cyclopentadienone of Formula (I) with a diethynyl arene of Formula (II) in one or more solvents,
wherein Formula (I) has the structure: 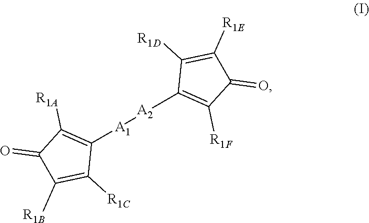
wherein Formula (II) has the structure: 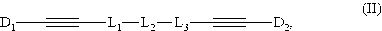
wherein:
R_{1A}, R_{1B}, R_{1C}, R_{1D}, R_{1E}, and R_{1F} are independently aryl or heteroaryl, each unsubstituted or substituted with 1, 2, 3, 4, or 5 substituents independently selected from C₁₋₆ alkyl, halo, SO₃⁻X⁺, PO₃²⁻2X⁺, and COO⁻X⁺, and provided that at least two of R_{1A}, R_{1B}, R_{1C}, R_{1D}, R_{1E}, and R_{1F} are independently aryl or heteroaryl substituted with 1, 2, 3, 4, or 5 substituents independently selected from SO₃⁻X⁺, PO₃²⁻2X⁺, and COO⁻X⁺;
A₁ is arylene, heteroarylene, aralkylene, or heteroaralkylene, wherein said arylene, heteroarylene, aralkylene, and heteroaralkylene are unsubstituted or substituted with 1, 2, 3, or 4 substituents independently selected from halo, nitro, cyano, aryl, and heteroaryl;
A₂ is absent, arylene, or heteroarylene, wherein said arylene and heteroarylene are unsubstituted or substituted with 1, 2, 3, or 4 substituents independently selected from halo, nitro, cyano, aryl, and heteroaryl;
L₁ is an unsubstituted or substituted linking heteroatom, arylene, heteroarylene, aralkylene, or heteroaralkylene, wherein the arylene, heteroarylene, aralkylene, and heteroaralkylene are unsubstituted or substituted with 1, 2, 3, or 4 substituents independently selected from C₁₋₆ alkyl, halo, nitro, cyano, aryl, and heteroaryl;
L₂ and L₃ are each independently absent, arylene, or heteroarylene, wherein said arylene and heteroarylene are unsubstituted or substituted with 1, 2, 3, or 4 substituents independently selected from C₁₋₆ alkyl, halo, nitro, cyano, aryl, and heteroaryl;
D₁ and D₂ are each independently H, R_{1G}, or R_{1H};
R_{1G} and R_{1H} are each independently H, aryl, or heteroaryl, wherein the aryl and heteroaryl are unsubstituted or substituted with 1, 2, 3, 4, or 5 substituents independently selected from C₁₋₆ alkyl, halo, nitro, cyano, SO₃⁻X⁺, PO₃²⁻2X⁺, and COO⁻X⁺; and
X⁺ is H⁺ or a cation, and
wherein the one or more solvent is not nitrobenzene.

2. The method of claim 1, wherein each of the one or more solvents has a dielectric constant of at least about 3.6, a Hansen solubility parameter (δTotal) of 50 or less, a boiling point at atmospheric pressure between about 100° C. and about 600° C., or a combination thereof.

3. The method of claim 1, wherein the one or more solvent is selected from the group consisting of N,N′-dimethylacetamide, N,N′-dimethylformamide, sulfolane, propylene carbonate, ethylene carbonate, diethyl carbonate, dimethyl carbonate, dimethyl sulfoxide, diphenylether, glycerol, triethylphosphate, N-methyl-2-pyrrolidone, ethylacetoacetate, benzaldehyde, benzylalcohol, and a combination thereof.

4. (canceled)

5. The method of claim 1, wherein the one or more solvent has a dielectric constant of about 3.6 to about 80, a Hansen solubility parameter (δTotal) of about 18 to about 36, a boiling point at atmospheric pressure of between about 130° C. and about 250° C. or a combination thereof.

6. (canceled)

7. (canceled)

8. The method of claim 1, wherein the sulfonated polyphenylene polymer has a repeat unit (x) of Formula (III): 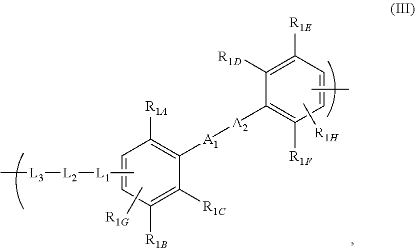
wherein:
R_{1A}, R_{1B}, R_{1C}, R_{1D}, R_{1E}, and R_{1F} are independently aryl or heteroaryl, each unsubstituted or substituted with 1, 2, 3, 4, or 5 substituents independently selected from C₁₋₆ alkyl, halo, nitro, cyano, SO₃⁻X⁺, PO₃²⁻2X⁺, and COO⁻X⁺, and provided that at least two of R_{1A}, R_{1B}, R_{1C}, R_{1D}, R_{1E}, and R_{1F} are independently aryl or heteroaryl substituted with 1, 2, 3, 4, or 5 substituents independently selected from SO₃⁻X⁺, PO₃²⁻2X⁺, and COO⁻X⁺;
R_{1G} and R_{1H} are each independently H, aryl, or heteroaryl, wherein said aryl and heteroaryl are unsubstituted or substituted with 1, 2, 3, 4, or 5 substituents independently selected from C₁₋₆ alkyl, halo, nitro, cyano, SO₃⁻X⁺, PO₃²⁻2X⁺, and COO⁻X⁺;
A₁ is arylene, heteroarylene, aralkylene, or heteroaralkylene, wherein said arylene, heteroarylene, aralkylene, and heteroaralkylene are unsubstituted or substituted with 1, 2, 3, or 4 substituents independently selected from halo, nitro, cyano, aryl, and heteroaryl;
A₂ is absent, arylene, or heteroarylene, wherein said arylene and heteroarylene are unsubstituted or substituted with 1, 2, 3, or 4 substituents independently selected from halo, nitro, cyano, aryl, and heteroaryl;
L₁ is an unsubstituted or substituted linking heteroatom, arylene, heteroarylene, aralkylene, or heteroaralkylene, wherein said arylene, heteroarylene, aralkylene, and heteroaralkylene are unsubstituted or substituted with 1, 2, 3, or 4 substituents independently selected from C₁₋₆ alkyl, halo, nitro, cyano, aryl, and heteroaryl;
L₂ and L₃ are each independently absent, arylene, or heteroarylene, wherein said arylene and heteroarylene are unsubstituted or substituted with 1, 2, 3, or 4 substituents independently selected from C₁₋₆ alkyl, halo, nitro, cyano, aryl, and heteroaryl; and
X⁺ is H⁺ or a cation.

9. The method of claim 1, further comprising polymerizing with a bis-cyclopentadienone of Formula (IV) to form a sulfonated polyphenylene copolymer, wherein Formula (IV) has the structure: 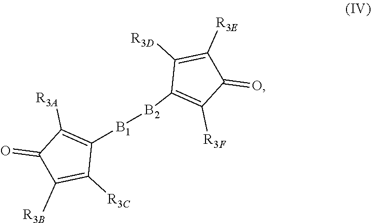
R_{3A}, R_{3B}, R_{3C}, R_{3D}, R_{3E}, and R_{3F} are independently aryl or heteroaryl, each unsubstituted or substituted with 1, 2, 3, 4, or 5 substituents independently selected from C₁₋₆ alkyl, halo, nitro, and cyano;
B₁ is arylene, heteroarylene, aralkylene, or heteroaralkylene, wherein said arylene, heteroarylene, aralkylene, and heteroaralkylene are unsubstituted or substituted with 1, 2, 3, or 4 substituents independently selected from halo, nitro, cyano, aryl, and heteroaryl; and
B₂ is absent, arylene, or heteroarylene, wherein said arylene and heteroarylene are unsubstituted or substituted with 1, 2, 3, or 4 substituents independently selected from halo, nitro, cyano, aryl, and heteroaryl.

10. The method of claim 9, wherein the sulfonated polyphenylene copolymer comprises a hydrophobic polyphenylene repeat unit (y) of Formula (V), wherein Formula (V) has the structure: 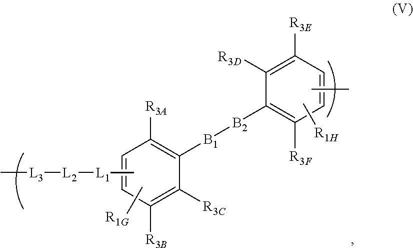
wherein:
R_{3A}, R_{3B}, R_{3C}, R_{3D}, R_{3E}, and R_{3F} are independently aryl or heteroaryl, each unsubstituted or substituted with 1, 2, 3, 4, or 5 substituents independently selected from C₁₋₆ alkyl, halo, nitro, and cyano;
R_{1G} and R_{1H} are independently H, aryl, or heteroaryl, wherein said aryl and heteroaryl are unsubstituted or substituted with 1, 2, 3, 4, or 5 substituents independently selected from C₁₋₆ alkyl, halo, nitro, and cyano;
B₁ is independently arylene, heteroarylene, aralkylene, or heteroaralkylene, wherein said arylene, heteroarylene, aralkylene, and heteroaralkylene are unsubstituted or substituted with 1, 2, 3, or 4 substituents independently selected from halo, nitro, cyano, aryl, and heteroaryl;
B₂ is independently absent, arylene, or heteroarylene, wherein said arylene and heteroarylene are unsubstituted or substituted with 1, 2, 3, or 4 substituents independently selected from halo, nitro, cyano, aryl, and heteroaryl;
L₁ is independently an unsubstituted or substituted linking heteroatom, arylene, heteroarylene, aralkylene, or heteroaralkylene, wherein said arylene, heteroarylene, aralkylene, and heteroaralkylene are each unsubstituted or substituted with 1, 2, 3, or 4 substituents independently selected from C₁₋₆ alkyl, halo, nitro, cyano, aryl, and heteroaryl; and
L₂ and L₃ are independently absent, arylene, or heteroarylene, wherein said arylene and heteroarylene are unsubstituted or substituted with 1, 2, 3, or 4 substituents independently selected from C₁₋₆ alkyl, halo, nitro, cyano, aryl, and heteroaryl.

11. The method of claim 9, wherein the sulfonated polyphenylene copolymer has a structure of Formula (VI): 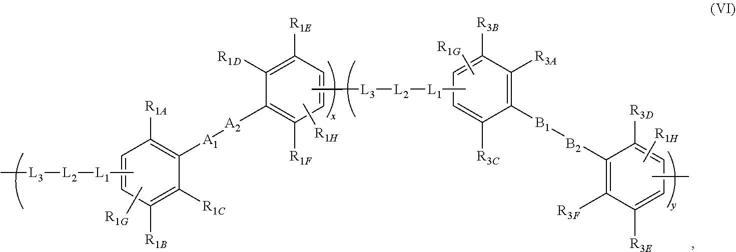
wherein:
R_{1A}, R_{1B}, R_{1C}, R_{1D}, R_{1E}, and R_{1F} are independently aryl or heteroaryl, each unsubstituted or substituted with 1, 2, 3, 4, or 5 substituents independently selected from C₁₋₆ alkyl, halo, nitro, cyano, SO₃⁻X⁺, PO₃²⁻2X⁺, and COO⁻X⁺;
R_{3A}, R_{3B}, R_{3C}, R_{3D}, R_{3E}, and R_{3F} are independently aryl or heteroaryl, each unsubstituted or substituted with 1, 2, 3, 4, or 5 substituents independently selected from C₁₋₆ alkyl, halo, nitro, and cyano;
R_{1G} and R_{1H} are each independently H, aryl, or heteroaryl, wherein said aryl and heteroaryl are unsubstituted or substituted with 1, 2, 3, 4, or 5 substituents independently selected from C₁₋₆ alkyl, halo, nitro, cyano, SO₃⁻X⁺, PO₃²⁻2X⁺, and COO⁻X⁺;
A₁ and B₁ are each independently arylene, heteroarylene, aralkylene, or heteroaralkylene, wherein said arylene, heteroarylene, aralkylene, and heteroaralkylene are unsubstituted or substituted with 1, 2, 3, or 4 substituents independently selected from C₁₋₆ alkyl, halo, nitro, cyano, aryl, and heteroaryl;
A₂ and B₂ are each independently absent, arylene, or heteroarylene, wherein said arylene and heteroarylene are unsubstituted or substituted with 1, 2, 3, or 4 substituents independently selected from C₁₋₆ alkyl, halo, nitro, cyano, aryl, and heteroaryl;
L₁ are each independently an unsubstituted or substituted linking heteroatom, arylene, heteroarylene, aralkylene, or heteroaralkylene, wherein said arylene, heteroarylene, aralkylene, and heteroaralkylene are unsubstituted or substituted with 1, 2, 3, or 4 substituents independently selected from C₁₋₆ alkyl, halo, nitro, cyano, aryl, and heteroaryl;
L₂ and L₃ are each independently absent, arylene, or heteroarylene, wherein said arylene and heteroarylene are unsubstituted or substituted with 1, 2, 3, or 4 substituents independently selected from C₁₋₆ alkyl, halo, nitro, cyano, aryl, and heteroaryl, and
X⁺ is H⁺ or a cation.

12. (canceled)

13. The method of claim 1, further comprising polymerizing with a triethynyl arene of Formula (VIII), to form a branched or hyperbranched structure, wherein Formula (VIII) has the structure: 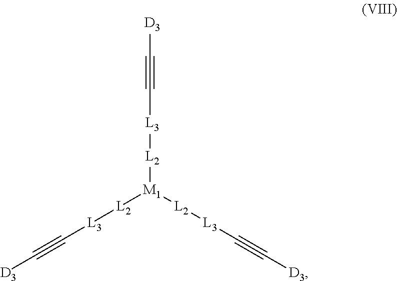
wherein
D₃ are each independently H, R_{1G}, or R_{1H}, and
M₁ is an unsubstituted or substituted linking atom, arylene, heteroarylene, aralkylene, or heteroaralkylene, wherein the arylene, heteroarylene, aralkylene, and heteroaralkylene are each unsubstituted or substituted with 1, 2, or 3 substituents independently selected from C₁₋₆ alkyl, halo, nitro, cyano, aryl, and heteroaryl.

14. The method of claim 13, wherein the branched or hyperbranched structure has a structure of Formula (IX): 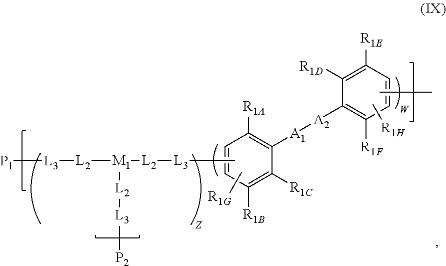
wherein P₁ and P₂ are independently selected from a repeat unit (x) of Formula (III) and a repeat unit (y) of Formula (V);
M₁ is an unsubstituted or substituted linking atom, arylene, heteroarylene, aralkylene, or heteroaralkylene, wherein the arylene, heteroarylene, aralkylene, and heteroaralkylene are unsubstituted or substituted with 1, 2, or 3 substituents independently selected from C₁₋₆ alkyl, halo, nitro, cyano, aryl, and heteroaryl;
L₂ and L₃ are each independently absent, arylene, or heteroarylene, wherein said arylene and heteroarylene are unsubstituted or substituted with 1, 2, 3, or 4 substituents independently selected from C₁₋₆ alkyl, halo, nitro, cyano, aryl, and heteroaryl;
A₁ is arylene, heteroarylene, aralkylene, or heteroaralkylene, wherein said arylene, heteroarylene, aralkylene, and heteroaralkylene are unsubstituted or substituted with 1, 2, 3, or 4 substituents independently selected from halo, nitro, cyano, aryl, and heteroaryl;
A₂ is absent, arylene, or heteroarylene, wherein said arylene and heteroarylene are unsubstituted or substituted with 1, 2, 3, or 4 substituents independently selected from halo, nitro, cyano, aryl, and heteroaryl;
R_{1A}, R_{1B}, R_{1C}, R_{1D}, R_{1E}, and R_{1F} are independently aryl or heteroaryl, each unsubstituted or substituted with 1, 2, 3, 4, or 5 substituents independently selected from C₁₋₆ alkyl, halo, SO₃⁻X⁺, PO₃²⁻2X⁺, and COO⁻X⁺, and provided that at least two of R_{1A}, R_{1B}, R_{1C}, R_{1D}, R_{1E}, and R_{1F} are independently aryl or heteroaryl substituted with 1, 2, 3, 4, or 5 substituents independently selected from SO₃⁻X⁺, PO₃²⁻2X⁺, and COO⁻X⁺;
R_{1G} and R_{1H} are independently H, aryl, or heteroaryl, wherein the aryl and heteroaryl are unsubstituted or substituted with 1, 2, 3, 4, or 5 substituents independently selected from C₁₋₆ alkyl, halo, nitro, cyano, SO₃⁻X⁺, PO₃²⁻2X⁺, and COO⁻X⁺; and
X⁺ is H⁺ or a cation, and
wherein a ratio of z:w is greater than 0.2.

15. The method of claim 13, wherein M₁ is bound through a covalent bond to at least 3 repeat units, and wherein M₁ is selected from the group consisting of:

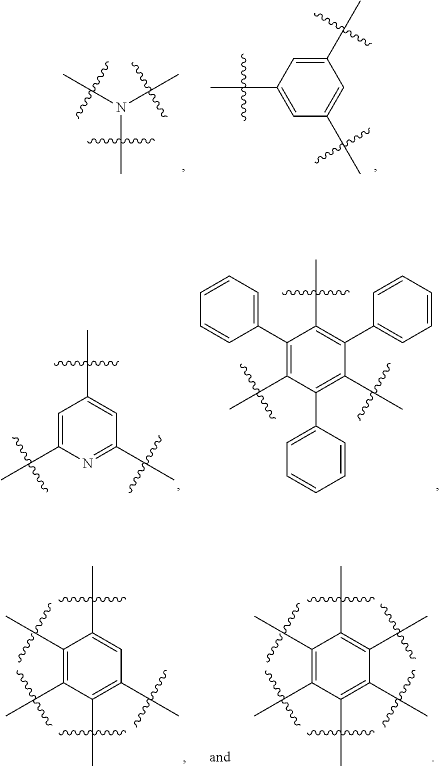

16. (canceled)

17. The method of claim 1, wherein R_{1A}, R_{1B}, R_{1C}, R_{1D}, R_{1E}, and R_{1F} are each independently aryl, wherein the aryl is unsubstituted or substituted with 1, 2, 3, 4, or 5 substituents each independently selected from C₁₋₆ alkyl, halo, and SO₃⁻X⁺, wherein X⁺ is H⁺ or a cation, and provided that at least two of R_{1A}, R_{1B}, R_{1C}, R_{1D}, R_{1E}, and R_{1F} are independently aryl substituted with 1, 2, 3, 4, or 5 SO₃⁻X⁺.

18. The method of claim 9, wherein R_{3A}, R_{3B}, R_{3C}, R_{3D}, R_{3E}, and R_{3F} are each independently aryl, wherein the aryl is unsubstituted or substituted with 1, 2, 3, 4, or 5 substituents each independently selected from C₁₋₆ alkyl and halo.

19. The method of claim 1, wherein A₁ is arylene, wherein the arylene is unsubstituted or substituted with 1, 2, 3, or 4 substituents each independently selected from halo, nitro, cyano, aryl, and heteroaryl, and A₂ is absent.

20. The method of claim 9, wherein B₁ is arylene, wherein the arylene is unsubstituted or substituted with 1, 2, 3, or 4 substituents each independently selected from halo, nitro, cyano, aryl, and heteroaryl, and B₂ is absent.

21. (canceled)

22. The method of claim 1, wherein each L₃, L₂, and L₁ of -L₃-L₂-L₁-, and each L₃ and L₂, of -L₃-L₂-M₁-, when present, are independently selected from the group consisting of:

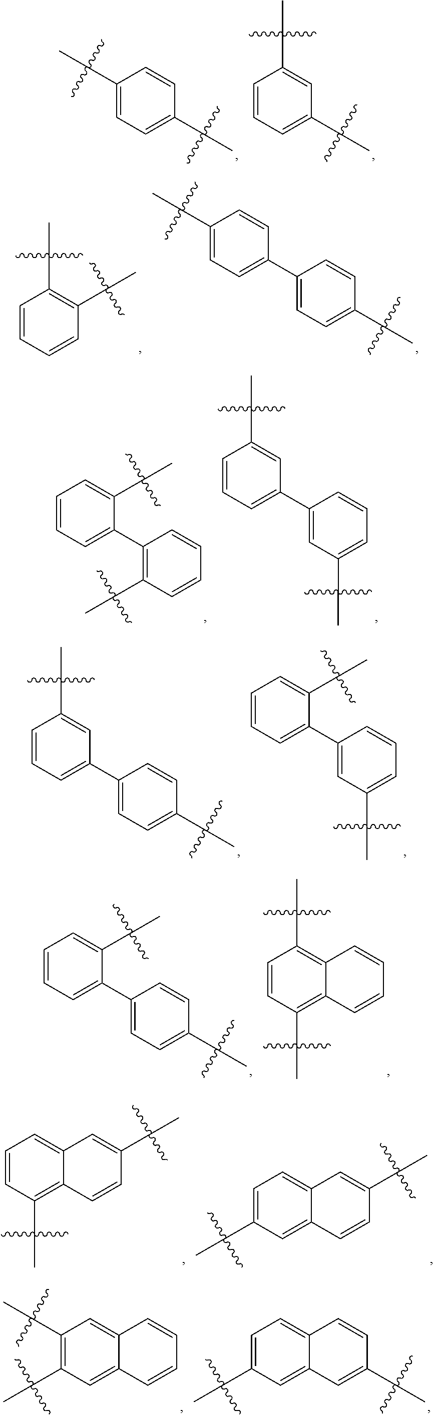

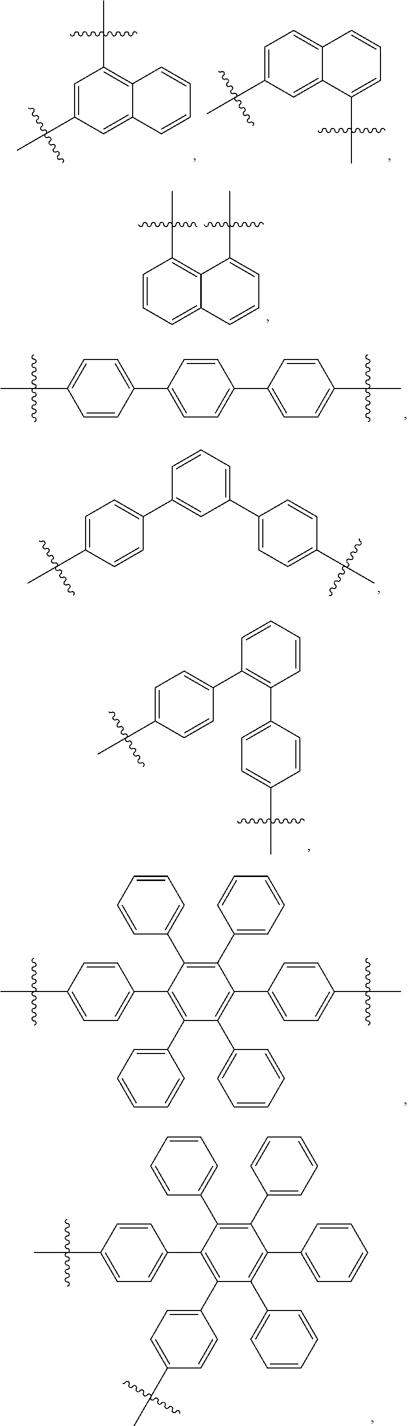

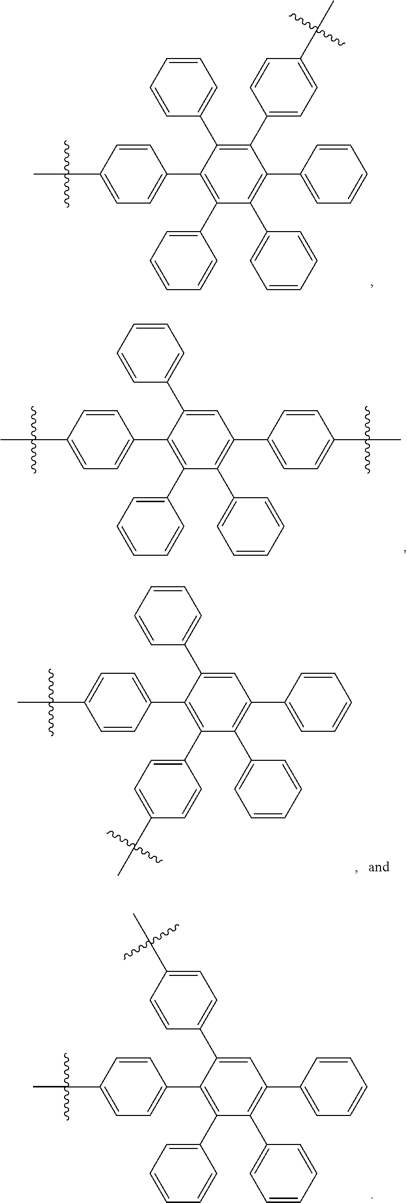

23. The method of claim 1, wherein the sulfonated polyphenylene polymer repeat unit (x) of Formula (III) is selected from: 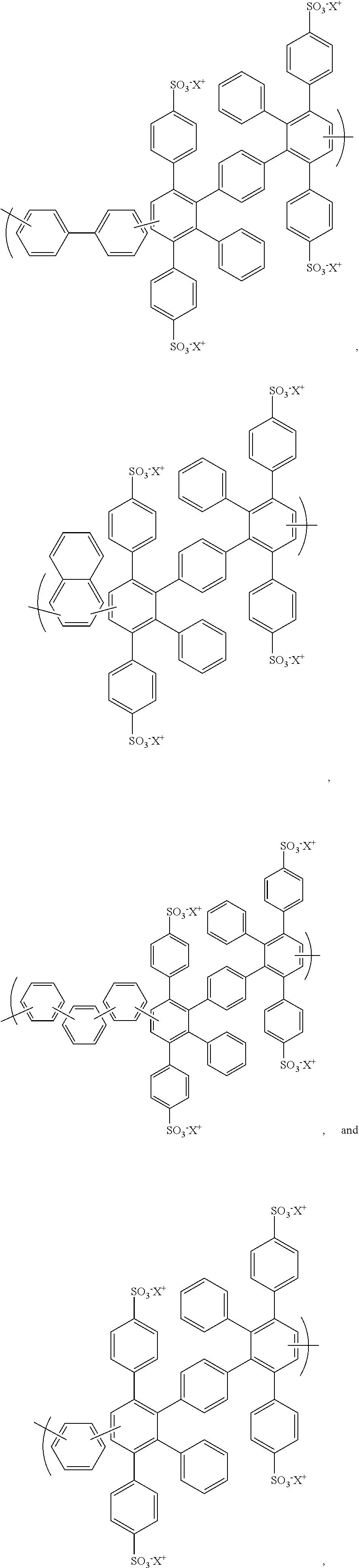
wherein X⁺ is H⁺, or a cation.

24. (canceled)

25. The method of claim 9, wherein the hydrophobic polyphenylene repeat unit (y) of Formula (V) is selected from:

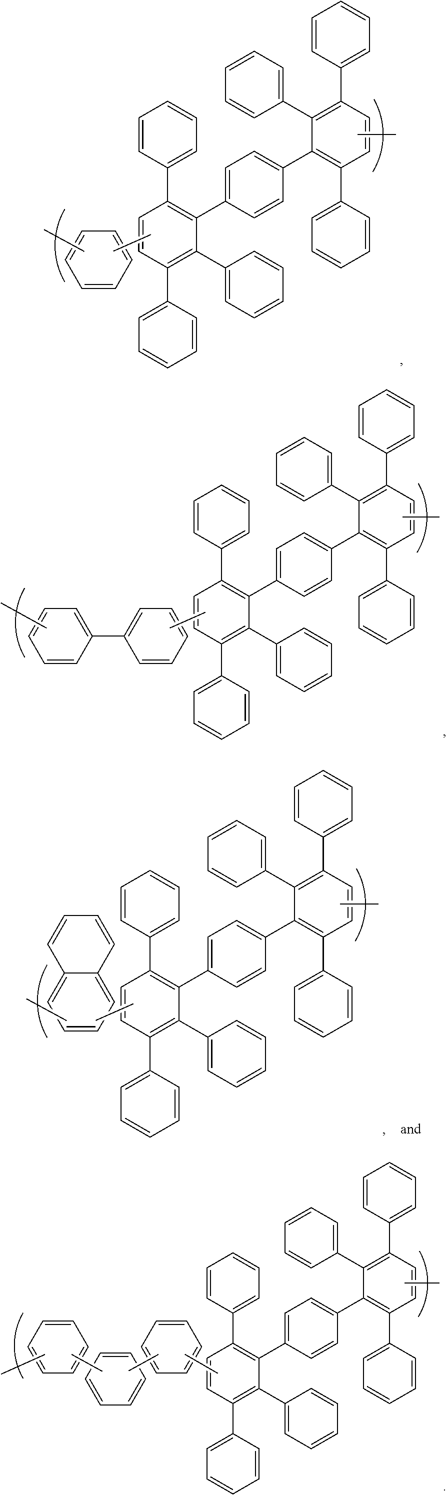

26. (canceled)

27. The method of claim 9, wherein the polymerizing comprises about a 59-99 mole % of the sulfonated bis-cyclopentadienone of Formula (I) and about 41-1 mole % of the bis-cyclopentadienone of Formula (IV).

28. The method of claim 11, wherein the mole percent of (x) is about 59% to about 99%, and the mole percent of (y) is about 41% to about 1%.

29. The method of claim 9, wherein the polymerizing comprises about a 90:10 ratio of the sulfonated bis-cyclopentadienone of Formula (I) to the bis-cyclopentadienone of Formula (IV).

30. (canceled)

31. The method of claim 9, wherein the sulfonated polyphenylene copolymer is a random copolymer comprising a random distribution of Formula (III) and Formula (V), and wherein a mole ratio of the sulfonated polyphenylene polymer repeat unit (x) of Formula (III) to the hydrophobic polyphenylene repeat unit (y) of Formula (V) ranges from about 1:99 to about 99:1.

32. The method of claim 9, wherein the sulfonated polyphenylene copolymer is a statistical copolymer comprising an average composition ratio of the repeat unit (x) of Formula (III) and repeat unit (y) of Formula (V).

33. The method of claim 9, wherein the sulfonated polyphenylene copolymer is a random block copolymer wherein:
(x) is an integer from 3 to 100,
(y) is an integer from 3 to 100; and
wherein a mole ratio of a first block to a second block ranges from about 1:99 to about 99:1.

34. The method of claim 1, wherein X⁺ is H⁺; a cation; an alkali metal ion; [N(R_{A})(R_{B})(R_{C})(R_{D})]⁺ wherein R_{A}, R_{B}, R_{C}, and R_{D} are independently H, C₁₋₆ alkyl, aryl, or heteroaryl; or a combination thereof.

35.-40. (canceled)

41. The method of claim 1, wherein the polymerizing further comprises one or more steps of:
(i) adding the one or more solvents to a reaction vessel, followed by adding the cyclopentadienone of Formula (I), the cyclopentadienone of Formula (IV), the diethynyl arene of Formula (II), the triethynyl arene of Formula (VIII), or a combination thereof, at a temperature of about 20-25° C., to the reaction vessel;
(ii) mixing the cyclopentadienone of Formula (I), the cyclopentadienone of Formula (IV), the diethynyl arene of Formula (II), the triethynyl arene of Formula (VIII), or a combination thereof, in the reaction vessel by stirring or mechanical mixing to form a reaction mixture;
(iii) purging the reaction mixture with an inert gas (e.g., N₂ or Ar);
(iv) heating the reaction mixture to a temperature of about 130° C. to about 170° C. while mixing and maintaining a blanket of the inert gas over the reaction mixture or in the reaction vessel;
(v) maintaining the temperature of about 130° C. to about 170° C. for about 4 hours to about 100 hours;
(vi) cooling the mixture and adding a polar solvent;
(vii) adding 2M NaOH to produce a precipitate;
(viii) filtering and drying the precipitate to produce a dry polymer;
(ix) adding 2M HCl to the dry polymer and mixing to form a slurry;
(x) filtering and washing the slurry with deionized water until the deionized water elutes at a neutral pH to form a polymer; and
(xi) drying the polymer at about 70° C. to about 90° C.

42. The method of claim 1, wherein the sulfonated polyphenylene polymer is used to form an ionomeric membrane.

43. The method of claim 1, wherein the sulfonated polyphenylene polymer, is incorporated into a catalyst layer of a fuel cell, of an electrolyzer, or of another electrochemical device.

44. An electrochemical device comprising the sulfonated polyphenylene polymer of claim 1, wherein the electrochemical device is a fuel cell, an electrolyzer, a redox flow battery, or another electrochemical device.

45. An electrochemical device comprising the ionomeric membrane of claim 42, wherein the electrochemical device is a fuel cell, an electrolyzer, a redox flow battery, or another electrochemical device.
